(19) United States
(12) Patent Application Publication
(10) Pub. No.: US 2024/0081329 A1
(43) Pub. Date: Mar. 14, 2024

(54) NON-PROTEIN PHENYLALANINE ANALOGUES FOR INHIBITING CYANOBACTERIA AND PLANT GROWTH

(71) Applicants: YISSUM RESEARCH DEVELOPMENT COMPANY OF THE HEBREW UNIVERSITY OF JERUSALEM LTD., Jerusalem (IL); YEDA RESEARCH AND DEVELOPMENT CO. LTD., Rehovot (IL)

(72) Inventors: Mark SAFRO, Rehovot (IL); Liron KLIPCAN, Rehovot (IL); Oren OSTERSETZER-BIRAN, Shoham (IL); Hagit ZER, Mevaseret Zion (IL)

(21) Appl. No.: 18/224,345

(22) Filed: Jul. 20, 2023

Related U.S. Application Data
(63) Continuation of application No. 15/999,587, filed on Aug. 16, 2018, now abandoned.
(60) Provisional application No. 62/376,443, filed on Aug. 18, 2016.
(60) Provisional application No. 62/295,600, filed on Feb. 16, 2016.

(51) Int. Cl. A01N 37/44; A01N 37/42; A01N 57/20

(52) U.S. Cl. CPC A01N 37/44; A01N 37/42; A01N 57/20

(57) ABSTRACT

Provided are methods of treating water and inhibiting growth of a photosynthetic bacterium, such as cyanobacterium as well as composition-of-matters and devices for treating water. Also provided are methods of using phenylalanine structural analogues as herbicides and/or combining same with a glyphosate.

### RELATED APPLICATIONS

This application is a continuation of U.S. patent application Ser. No. 15/999,587 filed on Aug. 16, 2018, which is a National Phase of PCT Patent Application No. PCT/IL2017/050209 having International filing date of Feb. 16, 2017, which claims the benefit of priority of U.S. Patent Application Nos. 62/295,600 filed on Feb. 16, 2016 and 62/376,443 filed on Aug. 18, 2016. The contents of the above applications are all incorporated by reference as if fully set forth herein in their entirety.

### REFERENCE TO AN ELECTRONIC SEQUENCE LISTING

The contents of the electronic sequence listing (FOT-P-001-US1 ST26.xml; size: 16,923 bytes; and date of creation: Nov. 20, 2023) is herein incorporated by reference in its entirety.

### FIELD AND BACKGROUND OF THE INVENTION

The present invention, in some embodiments thereof, relates to methods of treating water and inhibiting growth of a photosynthetic bacterium, such as cyanobacterium, and, more particularly, but not exclusively, to a use of phenylalanine (Phe) analogues, including meta-tyrosine (m-Tyr), for killing cyanobacterium. The present invention further relates in some embodiments to using phenylalanine structural analogues as herbicides, either alone or in combination with other herbicides such as glyphosate.

Non-Protein Amino Acids (NPAAs) are amino acids, which are not encoded by the genetic code of any organism. Despite the use of only 23 amino acids (21 in eukaryotes) by the translational machinery to assemble proteins (i.e. the proteinogenic amino acids), over 140 natural ‘non-protein’ amino acids are known, and thousands of more combinations of coded and non-coded amino acids are possible. In addition to the NPAAs that are naturally produced in plants, other NPAAs can be either designed synthetically or produced in vivo by the oxidation of amino acid side-chains (Rodgers and Shiozawa 2008). Certain structural analogues of the protein amino acids can escape detection by the cellular machinery of protein synthesis and therefore be mis-incorporated into the elongating polypeptide chain of proteins to generate non-native proteins. Several non-proteinogenic amino acids (i.e. non-canonical AAs) possess important biological roles. Few can be incorporated into the proteome, via biosynthetic pathways or introduced post-translationally into the proteome (e.g. via AA tRNA syntethases), and may thus affect cellular functions, resulting with altered growth and developmental phenotypes. Some possess a defined physiological role (e.g., neurotransmitters or toxins). Importantly, the non-proteinogenic amino acids, whether being produced naturally or commercially (e.g., synthetic compounds), have huge economical values as they can be utilized in the pharmaceutical industry and agriculture.

The meta-Tyrosine analog (also known as m-Tyr, 3-hydroxyphenylalanine or L-m-tyrosine) is a naturally occurring non-protein amino acid. Experimental data indicates that m-Tyr is produced by two main biosynthesis pathways: the pathway of dopamine synthesis; or by oxidation triggered by stresses leading to increased cellular reactive oxygen species (ROS) (Huang, T., et al., 2012). Although m-Tyr has been identified in small quantities in the cells of various organisms, m-Tyr is produced and accumulating to high levels in a few plant species, including fescues, and is most likely involved in allelopathic effects in plants. The term “allelopathy” refers to biological effects (inhibitory or stimulatory) of one organism (e.g., a plant), on other species. Metabolites, which are released by an organism and affect the growth or development of other organisms in the environment are generally termed as “allelochemicals”. The non amino acid m-Tyr is a plant-specific allelochemical.

The allelochemicals are usually secondary metabolites that can be synthesized in any of the plant parts, and can be beneficial (positive allelopathy) or detrimental (negative allelopathy) on the target organisms. Allelochemicals are not required for the metabolism (i.e., growth, development and reproduction) of the allelopathic (resistant) plant, but interfere with vital metabolic pathways of non-resistant species providing relative advantage to the resistant plant. The advantage of allelopathic effect of several widely used crop plants such as wheat, rice and cucumber is known and used. Lately the awareness of the potential to implement this phenomenon in weed management has risen.

As outlined above, meta-tyrosine is an allelochemical, which shows promising phytotoxic activity, e.g., inhibition of germination of angiosperms, including Arabidopsis thaliana, root growth (FIG. 2A and Bertin, C. et al. 2007) and was accordingly proposed as possible environmental-friendly weed suppressor for agricultural use [WO2006086474, “A bioherbicide from festuca spp”; and WO2013065048, “Transgenic plants resistant to non-protein amino acids” ]. It has been further suggested that the phytotoxicity of m-Tyr is caused by its incorporation into proteins in place of phenylalanine during protein synthesis.

Although m-Tyr is an efficient allelopathic agent, its direct application for agriculture use is limited due to its instability in soil and aqueous environment [Movellan, J. et al. Synthesis and evaluation as biodegradable herbicides of halogenated analogs of L-meta-tyrosine. Environ. Sci. Pollut. Res. 21, 4861-4870 (2014)].

Aminoacyl tRNA synthetases (aaRSs) ensure the integrity of the translation of the genetic code by covalently attaching an appropriate amino acid to the corresponding nucleic acid adaptor molecule—tRNA. The attachment of phenylalanine to a tRNA^{Phe} is catalyzed by a specific phenylalanyl-tRNA synthetase (PheRS). Phylogenetic and structural analyses suggest that there are three major forms of PheRS: (a) heterodimeric (αβ)₂ bacterial; (b) heterodimeric (αβ)₂ archaeal/eukaryotic-cytosolic; and (c) monomeric organellar (i.e. plastid and mitochondria) (Klipcan, L., et al., 2010).

The accuracy of the aminoacylation reaction by aaRSs (including PheRS) is based on precise recognition of the amino acid and tRNA substrates. However, due to stereo-chemical similarity shared by several amino acids, mistakes in the PheRS recognition can occur. Phenylalanine (Phe) and Tyrosine (Tyr) are distinguished by only one hydroxyl group at the aromatic ring and thus differentiation between Phe and Tyr is not always accurate (Kotik-Kogan, O., et al., 2005). One of the repair mechanisms involves a specific editing (or proofreading) activity by aaRSs at specific sites where misacylated tRNAs are hydrolyzed.

In freshwater systems, potential eutrophication-related losses are primarily due to cyanobacteria blooms. Cyanobacterial are known to produce a range of toxins that affect algae, fish, seabirds, turtles, marine mammals as well as humans. Thus, cyanobacterial blooms have a huge impact on marine biology (including ponds, rivers, lakes, and oceans), attributed to the production of biotoxins and oxygen depletion (hypoxia or anoxia) by massive bacterial respiration (Paerl, H 2014). Due to their immense negative impacts on the environment, economy (fishing industry, fish and shellfish growers, marine vessels, desalinizing facilities and turbines) and human health, the cyanobacterial blooms are carefully monitored globally. Marine and freshwater Harmful Algal Blooms (HABs) are estimated to cause an economic loss of several billion U.S. dollars annually [reported by the Scientific Committee on Oceanic Research (SCOR) and the Intergovernmental Oceanographic Commission (IOC) of UNESCO]. The danger of cyanotoxins was recently acknowledged by the World Health Organization (WHO), which issued provisional guides for drinking and recreational use for microcystin, the most ubiquitous cyanotoxin. While research, monitoring and management of toxic cyanobacterial are constantly advancing, there is still very little success in controlling it (Paerl, H. W. et al., 2013). Importantly, many cyanobacterial strains show a remarkable tolerance to known herbicides such as glyphosates. In fact, the only current application to cyano-blooms involves hydrogen peroxide (H₂O₂), which is added to the water (Burson, A. et al. 2014). Apparently, while certain concentration of H₂O₂ affect cyanobacteria, algae and zooplankton are less affected by this oxidant. However, while useful for small water containers, hydrogen peroxide is completely inapplicable for natural water reserves, rivers, ponds, lakes, oceans or fishponds.

In 2016, the Weed Science Society of America has concluded that corn and soybean yields would drop in the U.S. and Canada by 52%, and 49.5%, respectively, if producers didn't use herbicides and other weed control measures. This drop will lead to $43 billion (US) losses in crop production, per annum, based on a corn price of $4.94 per bushel (bu.) and soybeans at $10.61 per bu. In the research performed in Australia, the loss caused by weeds was estimated as 17-22% of the gross value of grain and oilseed production. In addition, roughly $1.5-2.3 billion is used on herbicides to kill nonindigenous crop weeds. It is estimated that weeds cause an overall 12% reduction in crop yields that is more than $43 billion in lost crop annually. Currently, several herbicides are present at the market, while the most used one, is world-wide distributed is glyphosate (Roundup) of Monsanto company (FIG. 7A).

The enzyme 5-enolpyruvyl-shikimate synthetase (EPSPS), which is active in plant and bacterial cells, catalyzes the conversion of phosphoenolpyruvate+3-phosphoshikimate to 5-enolpyruvyl-shikimate (EPSP) and phosphate. This enzyme is necessary for the synthesis of some amino acids at the start of the shikimic acid pathway. Glyphosate binds and blocks the activity of EPSPS, thereby inhibiting the biosynthesis of aromatic amino acids. Accordingly, attempts have been made to improve glyphosate performance. However, long exposure to the same herbicide resulted in appearance of herbicide tolerant weeds. Out of 58 cases of new glyphosate-resistant weeds identified in the last decade around the world, 31 were identified in the U.S.A., the country with world's largest area devoted to herbicide tolerant (HT) crops. Increasing resistance of weeds to existing agro-chemicals (FIGS. 7A and 8A-B) has stimulated demand for more selective cost effective chemicals. Only a limited number of herbicides, however, were introduced to farming and agriculture in the recent decades, none of which bare new modes of action (MOAs).

Recently, it has been discovered that several Phenylalanine-analogues (Phe-analogues) demonstrate herbicidal activity on a wide range of plants by slowing down roots development. Some of them cause significant inhibition of radicle elongation of both monocots and dicots. It was proposed that inhibitory effect may be achieved via misincorporation of Phe-analogues into plant proteins utilizing protein biosynthesis machinery. Interestingly, inhibition of A. thaliana roots growth by Phe-analogues is significantly counteracted by exogenous addition of phenylalanine to growth media.

### SUMMARY OF THE INVENTION

According to an aspect of some embodiments of the present invention there is provided a method of inhibiting growth of photosynthetic bacterium, the method comprising contacting an effective amount of a compound represented by Formula A:

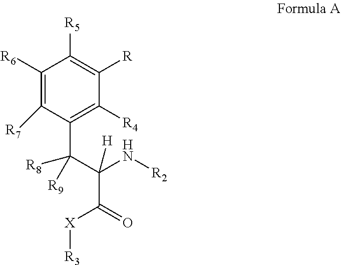

wherein:
R is selected from R₁ and OR₁₀,
R₁ is selected from alkyl, alkenyl, alkynyl, hydroxyalkyl, aminoalkyl, haloalkyl, halogen, nitro, cyano, amino, amidine, thiol, carboxy, and borate; R₁₀ is selected from H, sulfonate, sulfonamide, phosphonate, alkyl, alkenyl, alkynyl, alkoxy, alkoxycarbonyl, saccharide, cycloalkyl, heterocycloalkyl, aryl, and heteroaryl, wherein each of said phosphonate, alkyl, alkenyl, alkynyl, alkoxy, alkoxycarbonyl, saccharide, cycloalkyl, heterocycloalkyl, aryl, and heteroaryl is either substituted or unsubstituted;
R₂ is selected from H, sulfonate, sulfonamide, phosphonate, alkyl, alkenyl, alkynyl, alkoxy, carboxy, saccharide, cycloalkyl, heterocycloalkyl, aryl, and heteroaryl, wherein each of said phosphonate, alkyl, alkenyl, alkynyl, alkoxy, alkoxycarbonyl, saccharide, cycloalkyl, heterocycloalkyl, aryl, and heteroaryl is either substituted or unsubstituted;
R₃ is selected from H, alkyl, alkenyl, alkynyl, alkoxy, carboxy, saccharide, cycloalkyl, heterocycloalkyl, aryl, and heteroaryl, wherein each of said alkyl, alkenyl, alkynyl, alkoxy, carboxy, saccharide, cycloalkyl, heterocycloalkyl, aryl, and heteroaryl is either substituted or unsubstituted;
X is selected from the group consisting of O and N—Z, wherein Z is selected from the group consisting of H, alkyl, alkenyl, alkynyl, alkoxy, carboxy, saccharide, cycloalkyl, heterocycloalkyl, aryl, and heteroaryl, wherein each of said alkyl, alkenyl, alkynyl, alkoxy, alkoxycarbonyl, saccharide, cycloalkyl, heterocycloalkyl, aryl, and heteroaryl is either substituted or unsubstituted;
R₄, R₅, R₆, and R₇ are each independently selected from H, hydroxyl, halogen, amino, and nitro; and
R₈ and R₉ are independently selected from H, hydroxyl, halogen, amino, alkyl, and haloalkyl,
with the photosynthetic bacterium, thereby inhibiting the growth of the photosynthetic bacterium.

According to some embodiments of the invention, the R is R₁, the compound being represented by Formula I:

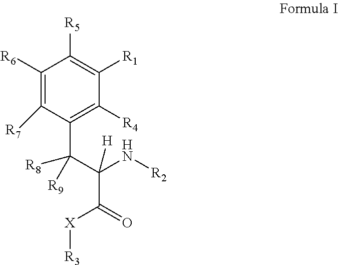

wherein:
R₁ is selected from alkyl, alkenyl, alkynyl, hydroxyalkyl, aminoalkyl, haloalkyl, halogen, nitro, cyano, amino, amidine, thiol, carboxy, and borate;
R₂ is selected from H, sulfonate, sulfonamide, phosphonate, alkyl, alkenyl, alkynyl, alkoxy, carboxy, saccharide, cycloalkyl, heterocycloalkyl, aryl, and heteroaryl, wherein each of said phosphonate, alkyl, alkenyl, alkynyl, alkoxy, alkoxycarbonyl, saccharide, cycloalkyl, heterocycloalkyl, aryl, and heteroaryl is either substituted or unsubstituted;
R₃ is selected from H, alkyl, alkenyl, alkynyl, alkoxy, carboxy, saccharide, cycloalkyl, heterocycloalkyl, aryl, and heteroaryl, wherein each of said alkyl, alkenyl, alkynyl, alkoxy, carboxy, saccharide, cycloalkyl, heterocycloalkyl, aryl, and heteroaryl is either substituted or unsubstituted;
X is selected from the group consisting of O and N—Z, wherein Z is selected from the group consisting of H, alkyl, alkenyl, alkynyl, alkoxy, carboxy, saccharide, cycloalkyl, heterocycloalkyl, aryl, and heteroaryl, wherein each of said alkyl, alkenyl, alkynyl, alkoxy, alkoxycarbonyl, saccharide, cycloalkyl, heterocycloalkyl, aryl, and heteroaryl is either substituted or unsubstituted;
R₄, R₅, R₆, and R₇ are each independently selected from H, hydroxyl, halogen, amino, and nitro; and
R₈ and R₉ are independently selected from H, hydroxyl, halogen, amino, alkyl, and haloalkyl.

According to some embodiments of the invention, the R₁ is selected from CH₃, CF₃, F, CN, Cl, Br, I, NO₂, 3-nitro-L-Tyrosine, 3,5-diiodo-L-Tyrosine; m-amidinophenyl-3-alanine, 3-ethyl-phenylalanine, meta-nitro-tyrosine, CH₂CH₃, NH₂, SH, C≡CH, —CH(CH₃)₂, —CH₂OH, —CH₂NH₂, —B(OH)₂, —C(CH₃)₃, and C(═O)OH. According to some embodiments of the invention, the R₁ is selected from —CH₃, —CF₃, —F, —CN, —Cl, —Br, —I, —NO₂, —CH₂CH₃, —NH₂, —SH, ethynyl (—C≡CH), —CH(CH₃)₂, —CH₂OH, —CH₂NH₂, —B(OH)₂, —C(CH₃)₃, or —C(═O)OH.

According to some embodiments of the invention, the R₁ is selected from CH₃, CF₃ and F.

According to some embodiments of the invention, the X is O.

According to some embodiments of the invention, the R₃-R₉ are each H.

According to some embodiments of the invention, the R is OR₁₀, the compound being represented by Formula II:

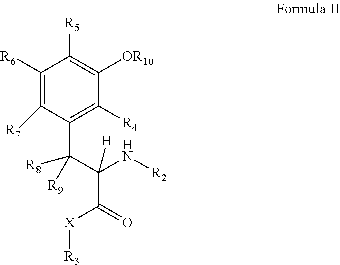

wherein:
R₁₀ is selected from H, sulfonate, sulfonamide, phosphonate, alkyl, alkenyl, alkynyl, alkoxy, alkoxycarbonyl, saccharide, cycloalkyl, heterocycloalkyl, aryl, and heteroaryl, wherein each of said phosphonate, alkyl, alkenyl, alkynyl, alkoxy, alkoxycarbonyl, saccharide, cycloalkyl, heterocycloalkyl, aryl, and heteroaryl is either substituted or unsubstituted;
R₂ is selected from H, sulfonate, sulfonamide, phosphonate, alkyl, alkenyl, alkynyl, alkoxy, carboxy, saccharide, cycloalkyl, heterocycloalkyl, aryl, and heteroaryl, wherein each of said phosphonate, alkyl, alkenyl, alkynyl, alkoxy, alkoxycarbonyl, saccharide, cycloalkyl, heterocycloalkyl, aryl, and heteroaryl is either substituted or unsubstituted;
R₃ is selected from H, alkyl, alkenyl, alkynyl, alkoxy, carboxy, saccharide, cycloalkyl, heterocycloalkyl, aryl, and heteroaryl, wherein each of said alkyl, alkenyl, alkynyl, alkoxy, carboxy, saccharide, cycloalkyl, heterocycloalkyl, aryl, and heteroaryl is either substituted or unsubstituted;
X is selected from the group consisting of O and N—Z, wherein Z is selected from the group consisting of H, alkyl, alkenyl, alkynyl, alkoxy, carboxy, saccharide, cycloalkyl, heterocycloalkyl, aryl, and heteroaryl, wherein each of said alkyl, alkenyl, alkynyl, alkoxy, alkoxycarbonyl, saccharide, cycloalkyl, heterocycloalkyl, aryl, and heteroaryl is either substituted or unsubstituted;
R₄, R₅, R₆, and R₇ are each independently selected from H, hydroxyl, halogen, amino, and nitro; and
R₈ and R₉ are independently selected from H, hydroxyl, halogen, amino, alkyl, and haloalkyl, with the photosynthetic bacterium, thereby inhibiting the growth of the photosynthetic bacterium.

According to some embodiments of the invention, the R₁₀ is H.

According to some embodiments of the invention, the X is O.

According to some embodiments of the invention, the R₃-R₉ are each H.

According to an aspect of some embodiments of the present invention there is provided a method of treating water, the method comprising contacting an effective amount of a compound represented by Formula A as defined herein, with the water, thereby treating the water.

According to an aspect of some embodiments of the present invention there is provided a composition-of-matter comprising a water-insoluble matrix and an effective amount of a compound represented by Formula A as defined in herein, incorporated in or on the matrix, the composition-of-matter being identified for use in treating water.

According to an aspect of some embodiments of the present invention there is provided a device for treating water comprising at least one casing having the composition-of-matter of some embodiments of the invention embedded therein such that water flowing through the casing becomes in contact with the composition-of-matter.

According to some embodiments of the invention, treating the water is effected by reducing a concentration of at least one photosynthetic bacterium in the water.

According to some embodiments of the invention, the compound is represented by Formula I as defined herein.

According to some embodiments of the invention, the compound is represented by formula II as defined herein.

According to some embodiments of the invention, the effective amount of the compound is capable of inhibiting growth of a photosynthetic bacterium comprised in the water.

According to some embodiments of the invention, the effective concentration of the compound is non-toxic to animals present in the water.

According to some embodiments of the invention, the photosynthetic bacterium comprises cyanobacterium.

According to an aspect of some embodiments of the present invention there is provided a method of inhibiting growth of a plant, the method comprising contacting an effective amount of the compound depicted by Formula I with the plant, thereby inhibiting the growth of the plant.

According to some embodiments of the invention, the plant comprises an angiosperm.

According to an aspect of some embodiments of the present invention there is provided an agricultural composition comprising the compound depicted by Formula I and an agricultural carrier.

According to some embodiments of the invention, the agricultural composition of some embodiments of the invention further comprising a herbicide, wherein the herbicide inhibits activity of 5-enolpyruvyl-shikimate synthetase (EPSPS) in a photosynthetic organism.

According to an aspect of some embodiments of the present invention there is provided an agricultural composition comprising the compound depicted by Formula A, I or II, a herbicide, and an agricultural carrier, wherein the herbicide inhibits activity of 5-enolpyruvyl-shikimate synthetase (EPSPS) in a photosynthetic organism.

According to some embodiments of the invention, the herbicide is glyphosate.

According to an aspect of some embodiments of the present invention there is provided a method inhibiting growth of a photosynthetic organism, the method comprising contacting the photosynthetic organism with a combination of an effective amount of the compound depicted by Formula A, I or II and an effective amount of a herbicide, wherein the herbicide inhibits activity of 5-enolpyruvyl-shikimate synthetase (EPSPS) in the photosynthetic organism, thereby inhibiting the growth of the photosynthetic organism.

According to some embodiments of the invention, the effective amount of the compound depicted by Formula A, I or II is provided prior to or concomitantly with the effective amount of the herbicide.

According to some embodiments of the invention, the effective amount of the herbicide is reduced as compared to an amount of the herbicide required for achieving the same growth inhibition of the photosynthetic organism when administered in the absence of the effective amount of the compound depicted by Formula A, I or II.

According to some embodiments of the invention, the herbicide is glyphosate.

According to some embodiments of the invention, the photosynthetic organism is a plant.

According to some embodiments of the invention, the plant comprises an angiosperm.

According to some embodiments of the invention, the plant comprises a weed or a weed seed.

According to some embodiments of the invention, the photosynthetic organism is a photosynthetic bacterium.

According to some embodiments of the invention, the photosynthetic bacterium comprises cyanobacterium.

According to some embodiments of the invention, the compound is represented by Formula I as defined herein.

According to some embodiments of the invention, the compound is represented by Formula II as defined herein.

According to an aspect of some embodiments of the present invention there is provided a method of growing a plant, comprising:
growing a plant over-expressing an aminoacyl tRNA synthetase (aaRS) as compared to an expression level of said aaRS in a wild type plant of the same species in the presence of an effective amount of a compound depicted by Formula I, wherein said effective amount of said compound is capable of inhibiting growth of said wild type plant of the same species, thereby growing the plant.

According to some embodiments of the invention, the aaRS is phenylalanyl-tRNA synthetase (PheRS).

According to some embodiments of the invention, the PheRS is a heterotetrameric bacterial PheRS composed of two PheRS-α and two PheRS-β strands.

According to some embodiments of the invention, the bacterial PheRS is selected from the group consisting of Escherichia coli (E. coli) PheRS and Thermus thermophilus PheRS.

According to some embodiments of the invention, the E. Coli PheRS-α is encoded by a polynucleotide having the nucleic acid sequence set forth in SEQ ID NO: 1 and the E. Coli PheRS-β is encoded by a polynucleotide having the nucleic acid sequence set forth in SEQ ID NO:2.

According to some embodiments of the invention, the E. Coli PheRS-α comprises the amino acid sequence set forth in SEQ ID NO:3 and the E. Coli PheRS-β comprises the amino acid sequence set forth in SEQ ID NO:4.

According to some embodiments of the invention, the T. thermophilus PheRS-α comprises the amino acid sequence set forth in SEQ ID NO:5 and the T. thermophilus PheRS-β² comprises the amino acid sequence set forth in SEQ ID NO:6.

According to some embodiments of the invention, the aminoacyl tRNA synthetase (aaRS) is encoded by a polynucleotide which further comprises a nucleic acid sequence encoding a targeting peptide selected from the group consisting of a mitochondrial targeting peptide and a chloroplast targeting peptide.

According to some embodiments of the invention, the plant is a crop plant.

According to some embodiments of the invention, the plant is an ornamental plant.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings/images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 depicts chemical structures of exemplary phenylalanine analogs according to some embodiments of the present invention.

FIGS. 2A-D are images depicting the effects of m-Tyr and several other phenylalanine (Phe)-analogs, modified in the meta position of the R-group, on Arabidopsis thaliana (var. Columbia) seed-germination and seedlings establishment. FIG. 2A—m-Tyr; FIG. 2B—Phe-analog “CH3”; FIG. 2C—Phe-analog “F”; FIG. 2D—Phe-analog “CF3”.

FIGS. 3A-B depict the inhibition of cyanobacteria by the phenylalanine analogue of some embodiments of the invention (“F”). FIG. 3A—a graph depicting the inhibition of growth of cyanobacteria Synechocystis PCC 6803 by increasing concentrations of the phenylalanine analogue of some embodiments of the invention. FIG. 3B—raw data of the results shown in FIG. 3A as detected after 150 hours.

FIG. 4 depicts the structure of m-Tyr compound.

FIGS. 5A-E depict the effect of m-Tyr on killing cyanobacteria Microcystis aeruginosa (FIGS. 5A-B) and Synechocystis PCC 6803 (FIGS. 5C-E) from water samples. FIG. 5A is a graph depicting the effects of m-Tyr on lake Kinneret samples containing the highly toxic cyanobacteria, Microcystis aeruginosa. The tests were performed with samples collected from lake Kinneret, that are contaminated by its native toxic cyanobacteria Microcystis aeruginosa, in the absence (0) or presence of various m-Tyr concentrations (1-20 μM) as indicated. The cell mortality is evaluated by the obvious bleaching of the culture. The growth rate was determined by the culture absorbance at OD=730. FIG. 5B—raw data of the water samples used in the experiment shown in FIG. 5A, in the presence of the indicated concentrations of m-Tyr. FIG. 5C—a graph depicting the effects of m-Tyr on the cyanobacteria, Synechocystis PCC 6803. The tests were performed with samples of Synechocystis PCC 6803, in the absence (0) or presence of various m-Tyr concentrations (1-1000 μM) as indicated. The cell mortality is evaluated by the obvious bleaching of the culture. The growth rate was determined by the culture absorbance at OD=730. FIG. 5D—raw data of the water samples used in the experiment shown in FIG. 5C, in the presence of the indicated concentrations of m-Tyr. FIG. 5E—The cell mortality of the cyanobacteria Synechocystis PCC 6803 was evaluated by the numbers of colonies appearing on Agar plates.

FIGS. 6A-B depict the effects of m-Tyr on the growth rates of model gram-positive and gram-negative bacteria. Bacterial growth was determined using optical density data (OD=600 nm) of E. coli and B. subtilis cultures at different time points and at different m-Tyr concentrations (0-1000 μM, the color index for m-Tyr concentration used is in the right side of each panel). FIG. 6A—E. coli; FIG. 6B—Bacillus subtilis; Note that cell growth of E. coli and Bacillus subtilis was not affected by m-Tyr, even when used at high concentrations of 1000 micromolar.

FIG. 7A depicts resistance to various types of herbicides in USA (in red color presented resistance to Glyphosate).

FIG. 7B depicts an image of a Palmer Amaranth.

FIGS. 8A-B depict changes in glyphosate resistance during winter (FIG. 8A) and summer (FIG. 8B) recent years in Australia (information adopted from Australian Glyphosate Sustainability Working Group).

FIG. 9 is an image depicting the effects of Phe-analogs, glyphosate and combination thereof on Arabidopsis thaliana (var. Columbia) seed-germination and seedlings establishment. “ZYX1”=m-Tyr (3′ OH phenylalanine); “ZYX2”=3′ fluoro phenylalanine; “RoundUp”=Glyphosate; “uM”=μicromolar.

FIG. 10 is an image depicting the effects of Phe-analogs, on glyphosate resistant Lolium rigidum Gaudin (weed) seed-germination and seedlings establishment. ZYX1=m-Tyr; “RoundUp”=Glyphosate; “uM”=μicromolar.

### DESCRIPTION OF SPECIFIC EMBODIMENTS OF THE INVENTION

The present invention, in some embodiments thereof, relates to methods of treating water and inhibiting growth of a photosynthetic bacterium, such as cyanobacterium, and, more particularly, but not exclusively, to a use of phenylalanine (Phe) analogues for killing cyanobacterium. The present invention further relates in some embodiments to using phenylalanine structural analogues as herbicides, either alone or in combination with other herbicides such as glyphosate.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

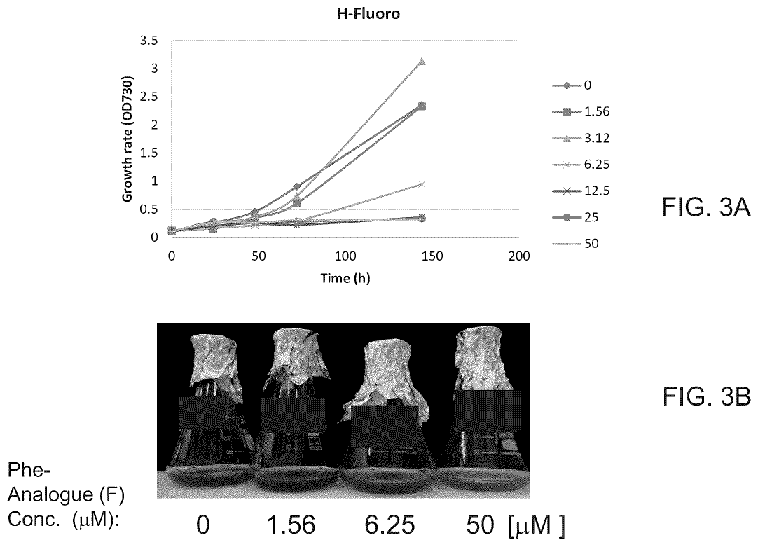

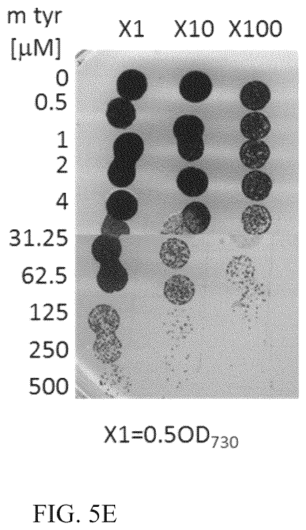

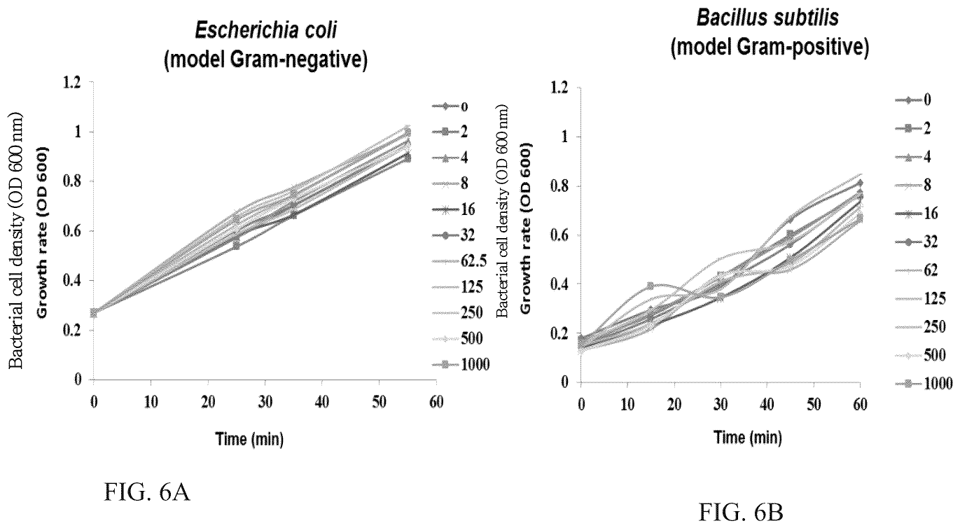

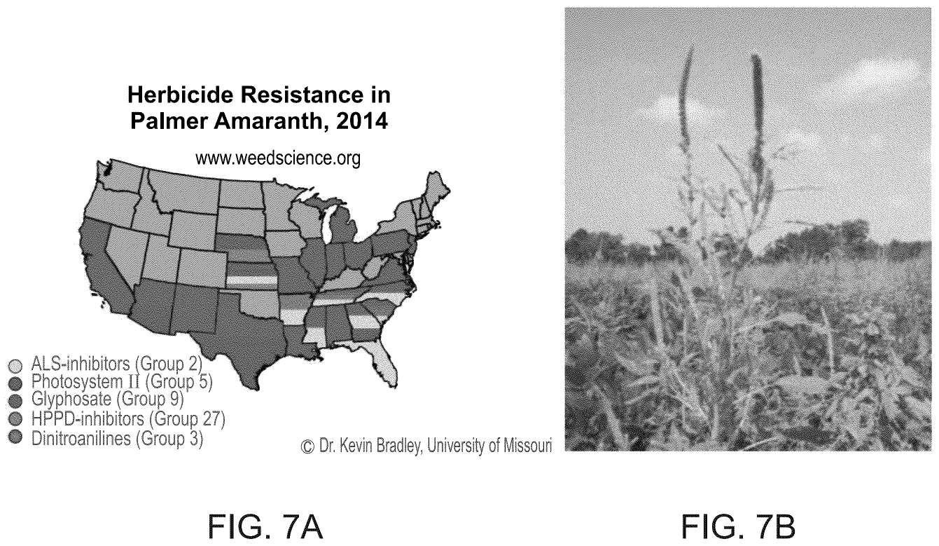

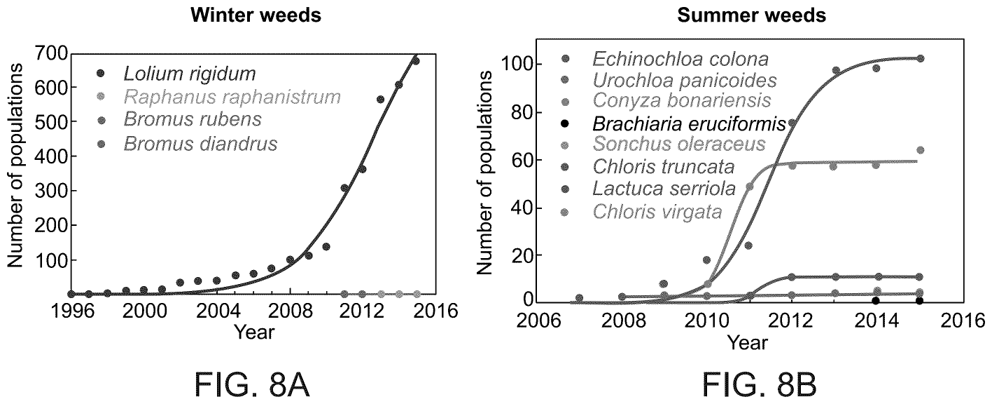

The present inventors have surprisingly uncovered, that the phenylalanine structural analogues (collectively represented in Formula A), including m-Tyr and analogues thereof, can be used as a specific bactericidal against photosynthetic organisms such as cyanobacteria (FIGS. 3A-B and 5A-B, Examples 3 and 4 of the Examples section which follows), known for their harmful effects on marine life, while not affecting other bacteria such as gram-negative or gram-positive bacteria (including Escherichia coli and Bacillus subtilis, respectively; FIGS. 6A-B and Example 4 of the Examples section which follows). This is the first evidence that the phenylalanine analogues, including m-Tyr, are highly toxic and selective against cyanobacteria.

The phenylalanine structural analogue(s) of some embodiments of the invention can be collectively represented by Formula A. Exemplary such compounds are collectively represented by Formula I and feature a substituent at the meta position, denoted as variable R₁ in Formula I, which is an alkyl, a haloalkyl (e.g., trihaloalkyl such as trifluoromethyl), or halogen such as fluorine.

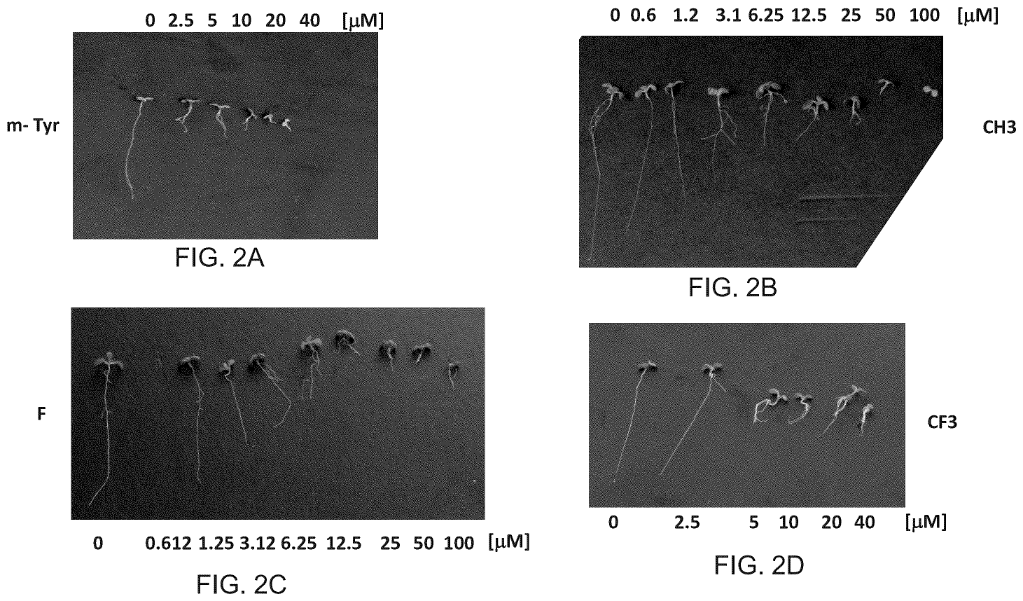

The present inventors have further addressed the molecular mechanisms of phenylalanine structural analogues in plants. The present inventors have uncovered that more stable Phenylalanine structural analogues, different from m-Tyr, affect the germination in plants. As shown in Examples 1-3 of the Examples section which follows, the present inventors demonstrate that phenylalanine-based structural analogues, which are more effective and stable inhibiting agents, can be used to control weed and cyanobacteria growth. Accordingly, the present inventors have tested numerous different analogues, some of which show higher stability and increased toxicity to plants and photosynthetic bacteria. Remarkably, these can be readily applied as highly effective new agents designed to control both weeds and cyanobacteria blooms, and accordingly can protect crops against yield loss from weeds. For example, growth defects (FIGS. 2A-D) and altered plastid morphologies coincide with the incorporation of the phenylalanine-based structural analogues into the plastid (and likely also the mitochondria) proteomes, whereas the eukaryotic organisms and bacteria, which lack plastids, are less affected by the toxic effects of the phenylalanine-based structural analogues (data not shown).

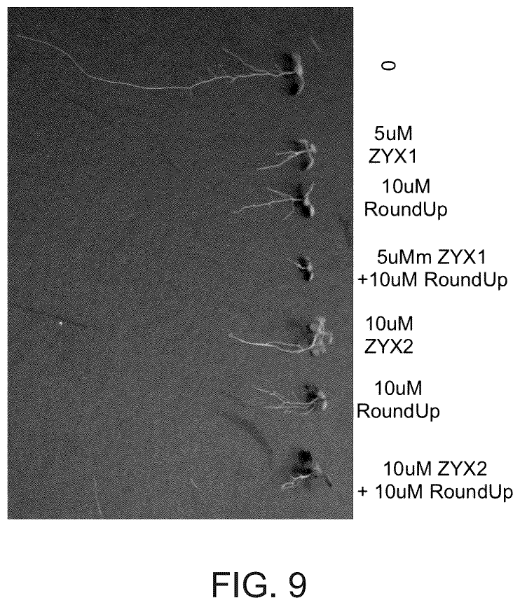

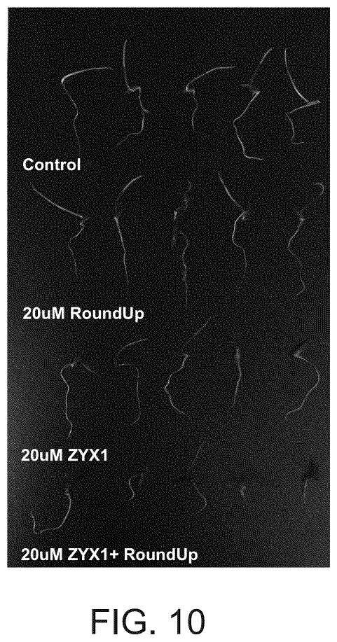

In addition, the present inventors have surprisingly shown a synergistic effect achieved by a combination of the phenylalanine-based structural analogues of some embodiments of the invention and a herbicide [e.g., the well known the glyphosate [known as “ROUNDUP™” (Monsanto Company)] which inhibits activity of 5-enolpyruvyl-shikimate synthetase (EPSPS) in a photosynthetic organism (FIGS. 9 and 10, and Example 5 of the Examples section which follows). Thus, these results show that (a) the glyphosate levels can be significantly reduced when applied together with phenylalanine-based structural analogues of some embodiments of the invention (Formulas A, I and II); and (b) glyphosate resistant plants become sensitive again (to glyphosate treatment) when phenylalanine-based structural analogues are added to the formulation.

Thus, according to an aspect of some embodiments of the invention, there is provided a method of inhibiting growth of a photosynthetic bacterium, the method comprising contacting an effective amount of a compound represented by Formula A (which is further described herein) with the photosynthetic bacterium, thereby inhibiting the growth of the photosynthetic bacterium.

As used herein the term “effective amount” refers to an amount of an agent (e.g., the compound represented by Formulas A, I or II) which is capable of inhibiting the growth of the photosynthetic bacterium of some embodiments of the invention by at least 10%, at least 20%, e.g., at least 30%, e.g., at least 40%, e.g., at least 50%, e.g., at least 60%, e.g., at least 70%, e.g., at least 80%, e.g., at least 90%, e.g., at least 95%, e.g., 100%, as compared to the growth of the photosynthetic bacterium in the absence of the agent under the same growth conditions (e.g., in water).

As used herein the phrase “photosynthetic bacterium” refers to a bacterium capable of performing photosynthesis.

The photosynthetic bacterium contains light absorbing pigments and reaction centers which make them capable of converting light energy into chemical energy.

Photosynthetic bacteria include aerobic and anaerobic bacteria.

In plants, algae, and cyanobacteria, photosynthesis releases oxygen. This is called “oxygenic photosynthesis” and is by far the most common type of photosynthesis used by living organisms. Although there are some differences between oxygenic photosynthesis in plants, algae, and cyanobacteria, the overall process is quite similar in these organisms. Most organisms that utilize oxygenic photosynthesis use visible light for the light-dependent reactions, although at least three use shortwave infrared or more specifically, far-red radiation.

Bacterial “anoxygenic photosynthesis” is distinguished from the more familiar terrestrial plant oxygenic photosynthesis by the nature of the terminal reductant (e.g. hydrogen sulfide rather than water) and in the byproduct generated (e.g., elemental sulfur instead of molecular oxygen). As its name implies, anoxygenic photosynthesis does not produce oxygen as a byproduct of the reaction. Additionally, all known organisms that carry out anoxygenic photosynthesis are obligate anaerobes. Several groups of bacteria can conduct anoxygenic photosynthesis, these include, for example, green sulfur bacteria (GSB), red and green filamentous phototrophs (FAPs, such as Chloroflexi), purple bacteria, Acidobacteria, and heliobacteria.

As mentioned above, cyanobacteria (also called “Cyanophyta”) are aerobic bacteria.

As used herein the term “cyanobacterium” or “cyanobacteria” (in plural) refers to a group of photosynthetic bacteria (phylum Cyanobacteria) containing a blue photosynthetic pigment.

Cyanobacteria are often blue-green in color and are thought to have contributed to the biodiversity on Earth by helping to convert the Earth's early oxygen-deficient atmosphere to an oxygen-rich environment. There are several species of Cyanobacteria. Non-limiting examples of cyanobacteria include: Gloeobacteria, the Nostocales (e.g. Microchaetaceae, Nostocaceae, Rivulariaceae, Scytonemataceae) the Oscillatoriophycideae, the Pleurocapsales, the Prochlorales (prochlorophytes), the Stigonematales, and various other yet unclassified Cyanobacteria (as arctic cyanobacterium 65RS1, the Bahamian heterocystous cyanobacterium C1C5 among others).

According to some embodiments of the invention, the cyanobacteria are Synechocystis PCC 6803 (Oscillatoriophycideae) and/or the toxic cyanobacteria Microcystis aeruginosa (Oscillatoriophycideae).

According to some embodiments of the invention, the effective amount of the agent is capable of killing the photosynthetic bacterium present in water.

Thus, the present inventors have uncovered a method of treating water, the method comprising contacting an effective amount of a compound represented by Formula A as defined herein with the water, thereby treating the water.

As used herein the phrase “treating water” refers to at least inhibiting growth of a photosynthetic bacterium contained within the water.

According to some embodiments of the invention, the effective amount of the agent (e.g., according to Formulas A, I or II) is capable of killing at least 1%, e.g., at least 2%, e.g., at least 3%, e.g., at least 4%, e.g., at least 5%, e.g., at least 6%, e.g., at least 7%, e.g., at least 8%, e.g., at least 9%, e.g., at least 10%, e.g., at least 11%, e.g., at least 12%, e.g., at least 13%, e.g., at least 14%, e.g., at least 15%, e.g., at least 16%, e.g., at least 17%, e.g., at least 18%, e.g., at least 19%, e.g., at least 20%, e.g., at least 25%, e.g., at least 30%, e.g., at least 40%, e.g., at least 50%, e.g., at least 60%, e.g., at least 70%, e.g., at least 80%, e.g., at least 90%, e.g., at least 95% e.g., at least 99%, e.g., 100% of the photosynthetic bacterium present in a predetermined volume of a water sample as compared to the quantity of photosynthetic bacterium present in the same predetermined volume of the water sample in the absence of the agent under the same conditions and the same period of time.

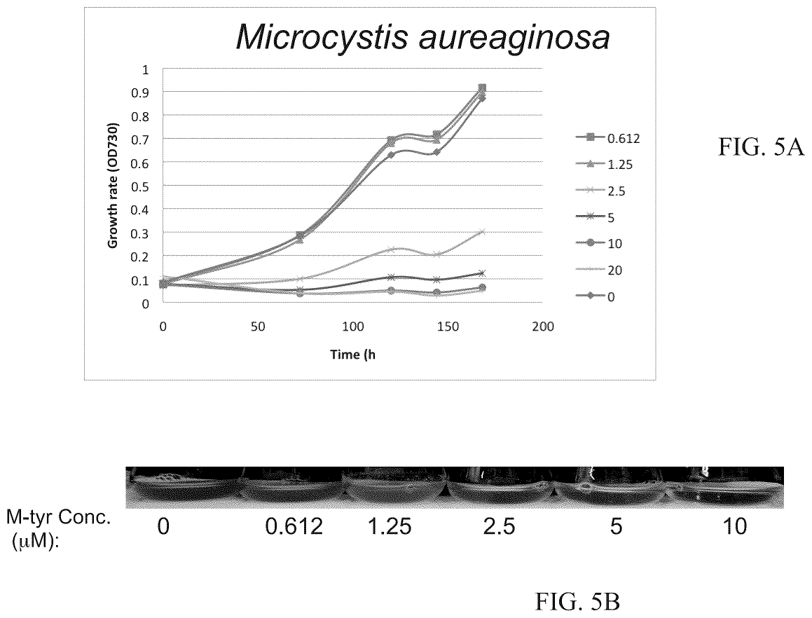

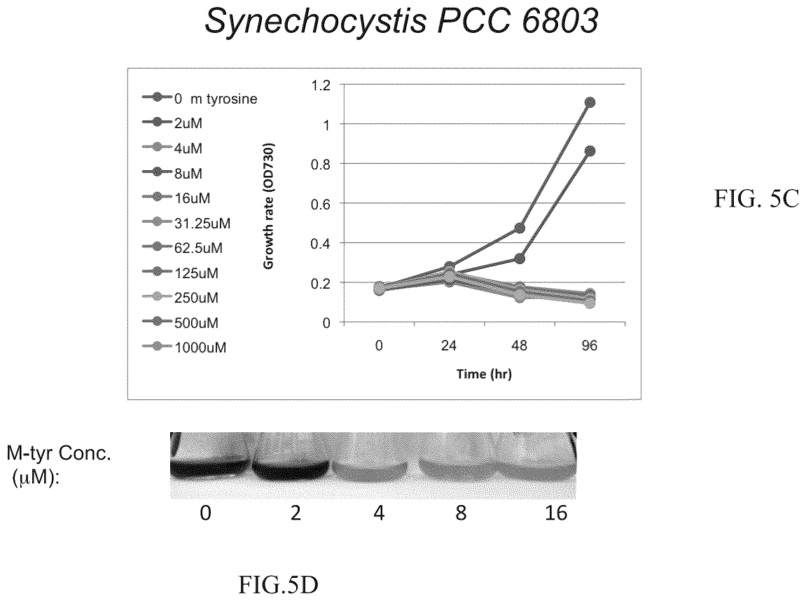

As described in Example 4 of the Examples section which follows, meta tyrosine was found effective in inhibiting growth and killing of Microcystis aeruginosa (FIGS. 5A-B) and Synechocystis PCC 6803 (FIGS. 5C-E).

In addition, as is described in Example 3 of the Examples section which follows, an exemplary phenylalanine analogue according to some embodiments of the invention, in which R₁ in Formula I is “F” was also found effective in inhibiting the growth and killing the Synechocystis PCC 6803 cyanobacteria (FIGS. 3A-B).

According to some embodiments the effective amount of the agent is between about 5 μM to about 100 μM, e.g., between about 5 μM to about 70 μM, e.g., between about 5 μM to about 50 μM, e.g., between 6-50 μM, e.g., between 6-25 μM, e.g., between 6-20 μM, e.g., between 6-12 μM of the compound depicted by Formula A.

According to some embodiments the effective amount of the agent is between about 1.5 μM to about 100 μM, e.g., between about 2 μM to about 70 μM, e.g., between about 3 μM to about 50 μM, e.g., between about 3 μM to about 30 μM, e.g., between about 3 μM to about 20 μM, e.g., between about 5 μM to about 20 μM, e.g., between about 5 μM to about 10 μM, e.g., between about 3 μM to about 10 μM, e.g., between about 3 μM to about 5 μM of the compound depicted by Formula I.

According to some embodiments the effective amount of the agent is between about 5 μM to about 100 μM, e.g., between about 5 μM to about 70 μM, e.g., between about 5 μM to about 50 μM, e.g., between 6-50 μM, e.g., between 6-25 μM, e.g., between 6-20 μM, e.g., between 6-12 μM of the compound depicted by Formula II.

Methods of monitoring the growth or death of the photosynthetic bacterium are known in the art. For example, the bacterial growth can be monitored by following absorbance at specific wave length, e.g., OD 730 (e.g., as shown in FIG. 3A).

According to some embodiments of the invention, the water which is treated by the method of some embodiments of the invention is used for drinking (e.g., for human being and/or for animals), swimming, industry, and/or for medicine.

According to an aspect of some embodiments of the invention there is provided a composition-of-matter comprising a water-insoluble matrix and an effective amount of a compound represented by Formula A as defined herein, incorporated in or on the matrix, the composition-of-matter being identified for use in treating water.

According to some embodiments of the invention, treating the water is effected by reducing a concentration of at least one photosynthetic bacterium in the water.

According to some embodiments of the invention, the photosynthetic bacterium comprises cyanobacterium.

According to some embodiments of the invention, the compound is represented by Formula I as defined herein.

According to some embodiments of the invention, the compound is represented by formula II as defined herein.

According to some embodiments of the invention, the effective amount of the compound of some embodiments of the invention (e.g., according to Formulas A, I or II) is capable of inhibiting growth of at least 1%, e.g., at least 2%, e.g., at least 3%, e.g., at least 4%, e.g., at least 5%, e.g., at least 6%, e.g., at least 7%, e.g., at least 8%, e.g., at least 9%, e.g., at least 10%, e.g., at least 11%, e.g., at least 12%, e.g., at least 13%, e.g., at least 14%, e.g., at least 15%, e.g., at least 16%, e.g., at least 17%, e.g., at least 18%, e.g., at least 19%, e.g., at least 20%, e.g., at least 25%, e.g., at least 30%, e.g., at least 40%, e.g., at least 50%, e.g., at least 60%, e.g., at least 70%, e.g., at least 80%, e.g., at least 90%, e.g., at least 95% e.g., at least 99%, e.g., 100% of the photosynthetic bacterium comprised in the water as compared to the growth of the photosynthetic bacterium comprised in the water in the absence of the compound under the same (e.g., identical) growth conditions.

According to some embodiments of the invention, the effective amount of the compound of some embodiments of the invention (e.g., according to Formulas A, I or II) is non-toxic to animals present in the water.

According to some embodiments of the invention, the water insoluble matrix is designed to carry the active agent (e.g., the compound represented by Formula A) and/or make it accessible for treating water. The water-insoluble matrix can be made of a polymeric or a non-polymeric material.

According to an aspect of some embodiments of the invention there is provided a device for treating water comprising at least one casing having the composition-of-matter of some embodiments of the invention embedded therein such that water flowing through the casing becomes in contact with the composition-of-matter.

The casing can be an in-situ or ex-situ unit for containing an effective amount of the composition-of-matter of some embodiments of the invention. Exemplary applicable in-situ units for containing the composition-of-matter of some embodiments of the invention are either in a form as at least part of a sub-surface water permeable reactive barrier (PRB) configured as a continuous filled in trench, wall, or stand-alone well, or, in a form as part of a sub-surface water pumping and treatment system. An exemplary applicable ex-situ unit for containing the composition-of-matter of some embodiments of the invention is in a form as part of an above-surface reactor which is part of an above-surface water pumping and treatment system. For treating contaminated water particularly being a form of water vapor and/or gaseous water, an exemplary applicable in-situ or ex-situ unit for containing the composition-of-matter of some embodiments of the invention is in a form as part of a variably locatable (sub-surface or above-surface) water treatment reactor system.

Exposing contaminated water to the composition-of-matter of some embodiments of the invention can be performed according to any of a variety of different ways. For implementing the present invention, preferably, the manner of exposure is such that the contaminated water, for example, in the form of contaminated sub-surface water, surface water, or above-surface water, naturally or forcibly, flows through, and is brought into physicochemical contact with composition-of-matter of some embodiments of the invention while the composition-of-matter of some embodiments of the invention remains essentially stationary. Moreover, preferably, the manner of exposure is such that the volumetric or mass flow rate of the contaminated water, naturally or forcibly, flowing through the composition-of-matter of some embodiments of the invention is at least equal to or larger than the volumetric or mass flow rate of the contaminated water, naturally or forcibly, flowing through the ground or material immediately surrounding the composition-of-matter of some embodiments of the invention. Accordingly, preferably, the manner of exposure is such that the permeability, k, of the composition-of-matter of some embodiments of the invention is at least equal to or larger than the permeability, k, of the ground or material immediately surrounding the composition-of-matter of some embodiments of the invention.

According to some embodiments of the invention, there is also provided an article-of-manufacture, which includes a packaging material, and the composition-of-matter of some embodiments of the invention, being contained within the packaging material, the composition-of-matter being identified for use in treating contaminated water.

As mentioned above and described in Examples 1 and 2 of the Examples section which follows, the present inventors have uncovered that more stable Phenylalanine structural analogues, different from m-Tyr, affect the germination in plants, and thus the present inventors have uncovered a method of treating a weed or weed seeds using the phenylalanine analogue of Formula I under conditions effective to inhibit growth of the weed or weed seed in a growth medium.

Thus, according to an aspect of some embodiments of the invention there is provided a method of inhibiting growth of a plant, the method comprising contacting an effective amount of the compound depicted by Formula I with the plant, thereby inhibiting the growth of the plant.

The term ‘“plant” as used herein encompasses whole plants, ancestors and progeny of the plants and plant parts, including seeds, shoots, stems, roots (including tubers), and plant cells, tissues and organs. The plant may be in any form including suspension cultures, embryos, meristematic regions, callus tissue, leaves, gametophytes, sporophytes, pollen, and microspores. Plants that are particularly useful in the methods of the invention include all plants which belong to the superfamily Viridiplantae, in particular monocotyledonous and dicotyledonous plants including a fodder or forage legume, ornamental plant, food crop, tree, or shrub selected from the list comprising Acacia spp., Acer spp., Actinidia spp., Aesculus spp., Agathis australis, Albizia amara, Alsophila tricolor, Andropogon spp., Arachis spp, Areca catechu, Astelia fragrans, Astragalus cicer, Baikiaea plurijuga, Betula spp., Brassica spp., Bruguiera gymnorrhiza, Burkea africana, Butea frondosa, Cadaba farinosa, Calliandra spp, Camellia sinensis, Canna indica, Capsicum spp., Cassia spp., Centroema pubescens, Chacoomeles spp., Cinnamomum cassia, Coffea arabica, Colophospermum mopane, Coronillia varia, Cotoneaster serotina, Crataegus spp., Cucumis spp., Cupressus spp., Cyathea dealbata, Cydonia oblonga, Cryptomeria japonica, Cymbopogon spp., Cynthea dealbata, Cydonia oblonga, Dalbergia monetaria, Davallia divaricata, Desmodium spp., Dicksonia squarosa, Dibeteropogon amplectens, Dioclea spp, Dolichos spp., Dorycnium rectum, Echinochloa pyramidalis, Ehraffia spp., Eleusine coracana, Eragrestis spp., Erythrina spp., Eucalypfus spp., Euclea schimperi, Eulalia vi/losa, Pagopyrum spp., Feijoa sellowlana, Fragaria spp., Flemingia spp, Freycinetia banksli, Geranium thunbergii, GinAgo biloba, Glycine javanica, Gliricidia spp, Gossypium hirsutum, Grevillea spp., Guibourtia coleosperma, Hedysarum spp., Hemaffhia altissima, Heteropogon contoffus, Hordeum vulgare, Hyparrhenia rufa, Hypericum erectum, Hypeffhelia dissolute, Indigo incamata, Iris spp., Leptarrhena pyrolifolia, Lespediza spp., Lettuca spp., Leucaena leucocephala, Loudetia simplex, Lotonus bainesli, Lotus spp., Macrotyloma axillare, Malus spp., Manihot esculenta, Medicago saliva, Metasequoia glyptostroboides, Musa sapientum, Nicotianum spp., Onobrychis spp., Ornithopus spp., Oryza spp., Peltophorum africanum, Pennisetum spp., Persea gratissima, Petunia spp., Phaseolus spp., Phoenix canariensis, Phormium cookianum, Photinia spp., Picea glauca, Pinus spp., Pisum sativam, Podocarpus totara, Pogonarthria fleckii, Pogonaffhria squarrosa, Populus spp., Prosopis cineraria, Pseudotsuga menziesii, Pterolobium stellatum, Pyrus communis, Quercus spp., Rhaphiolepsis umbellata, Rhopalostylis sapida, Rhus natalensis, Ribes grossularia, Ribes spp., Robinia pseudoacacia, Rosa spp., Rubus spp., Salix spp., Schyzachyrium sanguineum, Sciadopitys vefficillata, Sequoia sempervirens, Sequoiadendron giganteum, Sorghum bicolor, Spinacia spp., Sporobolus fimbriatus, Stiburus alopecuroides, Stylosanthos humilis, Tadehagi spp, Taxodium distichum, Themeda triandra, Trifolium spp., Triticum spp., Tsuga heterophylla, Vaccinium spp., Vicia spp., Vitis vinifera, Watsonia pyramidata, Zantedeschia aethiopica, Zea mays, amaranth, artichoke, asparagus, broccoli, Brussels sprouts, cabbage, canola, carrot, cauliflower, celery, collard greens, flax, kale, lentil, oilseed rape, okra, onion, potato, rice, soybean, straw, sugar beet, sugar cane, sunflower, tomato, squash tea, maize, wheat, barley, rye, oat, peanut, pea, lentil and alfalfa, cotton, rapeseed, canola, pepper, sunflower, tobacco, eggplant, eucalyptus, a tree, an ornamental plant, a perennial grass and a forage crop.

According to some embodiments of the invention, the plant is a vascular plant.

According to some embodiments of the invention, the plant comprises an angiosperm.

According to some embodiments of the invention, the effective amount of the agent according to Formula I is capable of inhibiting the growth of the plant by at least 1%, e.g., at least 2%, e.g., at least 3%, e.g., at least 4%, e.g., at least 5%, e.g., at least 6%, e.g., at least 7%, e.g., at least 8%, e.g., at least 9%, e.g., at least 10%, e.g., at least 11%, e.g., at least 12%, e.g., at least 13%, e.g., at least 14%, e.g., at least 15%, e.g., at least 16%, e.g., at least 17%, e.g., at least 18%, e.g., at least 19%, e.g., at least 20%, e.g., at least 25%, e.g., at least 30%, e.g., at least 40%, e.g., at least 50%, e.g., at least 60%, e.g., at least 70%, e.g., at least 80%, e.g., at least 90%, e.g., at least 95% e.g., at least 99%, e.g., 100% as compared to the growth of the same plant under the same growth conditions but being devoid of the effective amount of the agent.

Various parameters can be used to assess the growth of the plant, these include, for example, growth rate of leaf, root, petiole, rosette, leaf number, plant height, as well as the biomass, yield (e.g., oil yield, seed yield), root coverage, root length and the like.

According to an aspect of some embodiments of the invention there is provided an agricultural composition comprising the compound depicted by Formula I and an agricultural carrier.

According to some embodiments of the invention, the agricultural composition of some embodiments of the invention further comprising a herbicide, the herbicide inhibits activity of 5-enolpyruvyl-shikimate synthetase (EPSPS) in a photosynthetic organism.

As used herein the phrases “5-enolpyruvyl-shikimate synthetase” or “5-enolpyruvylshikimate-3-phosphate synthetase” or “EPSPS”, which are interchangeably used herein refer to the EC 2.5.1.19 enzyme targeted by the herbicide and inhibited thereby.

As mentioned above and described in Example 5 of the Examples section which follows, the present inventors have uncovered a synergistic effect achieved by a combination of the phenylalanine-based structural analogues of some embodiments of the invention and a herbicide which inhibits activity of 5-enolpyruvyl-shikimate synthetase (EPSPS) in a photosynthetic organism.

According to an aspect of some embodiments of the invention there is provided an agricultural composition comprising the compound depicted by Formula A, I or II, a herbicide, and an agricultural carrier, wherein the herbicide inhibits activity of 5-enolpyruvyl-shikimate synthetase (EPSPS) in a photosynthetic organism.

Herbicide(s), also known as “weedkillers”, are chemical substances used to control unwanted plants. The herbicides can be divided to selective herbicides which control specific weed species, while leaving the desired crop relatively unharmed, and non-selective herbicides (sometimes called “total weedkillers” in commercial products) can be used to clear waste ground, industrial and construction sites, railways and railway embankments as they kill all plant material with which they come into contact. Additionally or alternatively, the herbicides can be divided to synthetic or “organic” herbicides. “Organic” herbicides refer to agents which can be used in organic farms.

Following is a non-limiting list of synthetic herbicides which can be used according to some embodiments of the invention, these include for example, synthetic auxin (a plant hormone), e.g., 2,4-D (a broadleaf herbicide in the phenoxy group); Clopyralid (a broadleaf herbicide in the pyridine group), Dicamba (a postemergent broadleaf herbicide with some soil activity, is used on turf and field corn), Fluroxypyr (a systemic, selective herbicide, used for the control of broad-leaved weeds in small grain cereals, maize, pastures, rangeland and turf), Picloram (a pyridine herbicide, mainly is used to control unwanted trees in pastures and edges of fields); photosystem II inhibitors, e.g., Atrazine (a triazine herbicide, used in corn and sorghum for control of broadleaf weeds and grasses); EPSPs inhibitors, e.g., Glyphosate (a systemic nonselective herbicide, used in no-till burndown and for weed control in crops genetically modified to resist its effects); Aminopyralid (a broadleaf herbicide in the pyridine group, used to control weeds on grassland, such as docks, thistles and nettles); Glufosinate ammonium (a broad-spectrum contact herbicide, used to control weeds after the crop emerges or for total vegetation control on land not used for cultivation); Fluazifop (Fuselade Forte; a post emergence, foliar absorbed, translocated grass-selective herbicide with little residual action; used on a very wide range of broad leaved crops for control of annual and perennial grasses); Imazapyr (a nonselective herbicide, used for the control of a broad range of weeds, including terrestrial annual and perennial grasses and broadleaf herbs, woody species, and riparian and emergent aquatic species); Imazapic (a selective herbicide for both the pre- and postemergent control of some annual and perennial grasses and some broadleaf weeds, kills plants by inhibiting the production of branched chain amino acids (valine, leucine, and isoleucine), which are necessary for protein synthesis and cell growth); Imazamox (an imidazolinone manufactured by BASF for postemergence application that is an acetolactate synthase (ALS) inhibitor); Linuron (a nonselective herbicide used in the control of grasses and broadleaf weeds; works by inhibiting photosynthesis); MCPA (2-methyl-4-chlorophenoxyacetic acid; a phenoxy herbicide selective for broadleaf plants and widely used in cereals and pasture); Metolachlor (a pre-emergent herbicide widely used for control of annual grasses in corn and sorghum; it has displaced some of the atrazine in these uses); Paraquat (a nonselective contact herbicide used for no-till burndown and in aerial destruction of marijuana and coca plantings; more acutely toxic to people than any other herbicide in widespread commercial use); Pendimethalin (a pre-emergent herbicide, is widely used to control annual grasses and some broad-leaf weeds in a wide range of crops, including corn, soybeans, wheat, cotton, many tree and vine crops, and many turfgrass species); Sodium chlorate (a nonselective herbicide, considered phytotoxic to all green plant parts. It can also kill through root absorption); Triclopyr (a systemic, foliar herbicide in the pyridine group, used to control broadleaf weeds while leaving grasses and conifers unaffected); Several sulfonylureas, including Flazasulfuron and Metsulfuron-methyl (act as ALS inhibitors and in some cases are taken up from the soil via the roots).

According to some embodiments of the invention, the herbicide is glyphosate.

According to some embodiments of the invention, the photosynthetic organism is a plant.

According to some embodiments of the invention, the plant comprises an angiosperm.

According to some embodiments of the invention, the plant comprises a weed or a weed seed.

According to some embodiments of the invention, the photosynthetic organism is a photosynthetic bacterium.

According to some embodiments of the invention, the photosynthetic bacterium comprises cyanobacterium.

In some embodiments, the agricultural carrier may be soil or plant growth medium. Other agricultural carriers that may be used include fertilizers, plant-based oils, humectants, or combinations thereof. Alternatively, the agricultural carrier may be a solid, such as diatomaceous earth, loam, silica, alginate, clay, bentonite, vermiculite, seed cases, other plant and animal products, or combinations, including granules, pellets, or suspensions. Mixtures of any of the aforementioned ingredients are also contemplated as carriers, such as but not limited to, pesta (flour and kaolin clay), agar or flour-based pellets in loam, sand, or clay, etc. Formulations may include food sources for the cultured organisms, such as barley, rice, or other biological materials such as seed, leaf, root, plant elements, sugar cane bagasse, hulls or stalks from grain processing, ground plant material or wood from building site refuse, sawdust or small fibers from recycling of paper, fabric, or wood. Other suitable formulations will be known to those skilled in the art.

In some embodiments, the formulation can comprise additives, including but not limited to sticking agents, spreading agents, surfactants, synergists, penetrants, compatibility agents, buffers, acidifiers, defoaming agents, thickeners and drift retardants.

In some embodiments, the formulation can comprise a tackifier or adherent. Such agents are useful for combining the compound depicted by Formula A, I or II, and/or the herbicide of some embodiments of the invention with carriers that can contain other compounds (e.g., control agents that are not biologic), to yield a coating composition. Such compositions may aid to maintain contact between the compound depicted by Formula A, I or II, and/or the herbicide of some embodiments of the invention and the photosynthetic organism. In one embodiment, adherents are selected from the group consisting of: alginate, gums, starches, lecithins, formononetin, polyvinyl alcohol, alkali formononetinate, hesperetin, polyvinyl acetate, cephalins, Gum Arabic, Xanthan Gum, Mineral Oil, Polyethylene Glycol (PEG), Polyvinyl pyrrolidone (PVP), Arabino-galactan, Methyl Cellulose, PEG 400, Chitosan, Polyacrylamide, Polyacrylate, Polyacrylonitrile, Glycerol, Triethylene glycol, Vinyl Acetate, Gellan Gum, Polystyrene, Polyvinyl, Carboxymethyl cellulose, Gum Ghatti, and polyoxyethylene-polyoxybutylene block copolymers. Other examples of adherent compositions that can be used in the synthetic preparation include those described in EP 0818135, CA 1229497, WO 2013090628, EP 0192342, WO 2008103422 and CA 1041788, each of which is incorporated herein by reference in its entirety.

The formulation may also contain a surfactant. Non-limiting examples of surfactants include nitrogen-surfactant blends such as Prefer 28 (Cenex), Surf-N (US), Inhance (Brandt), P-28 (Wilfarm) and Patrol (Helena); esterified seed oils include Sun-It II (AmCy), MSO (UAP), Scoil (Agsco), Hasten (Wilfarm) and Mes-100 (Drexel); and organo-silicone surfactants include Silwet L77 (UAP), Silikin (Terra), Dyne-Amic (Helena), Kinetic (Helena), Sylgard 309 (Wilbur-Ellis) and Century (Precision). In one embodiment, the surfactant is present at a concentration of between 0.01% v/v to 10% v/v. In another embodiment, the surfactant is present at a concentration of between 0.1% v/v to 1% v/v.

In liquid form, for example, solutions or suspensions, the compound depicted by Formula A, I or II, and/or the herbicide of some embodiments of the invention can be mixed or suspended in aqueous solutions. Suitable liquid diluents or carriers include aqueous solutions, petroleum distillates, or other liquid carriers.

Solid compositions can be prepared by dispersing the compound depicted by Formula A, I or II, and/or the herbicide of some embodiments of the invention in and on an appropriately divided solid carrier, such as peat, wheat, bran, vermiculite, clay, talc, bentonite, diatomaceous earth, fuller's earth, pasteurized soil, and the like. When such formulations are used as wettable powders, biologically compatible dispersing agents such as non-ionic, anionic, amphoteric, or cationic dispersing and emulsifying agents can be used.

The solid carriers used upon formulation include, for example, mineral carriers such as kaolin clay, pyrophyllite, bentonite, montmorillonite, diatomaceous earth, acid white soil, vermiculite, and pearlite, and inorganic salts such as ammonium sulfate, ammonium phosphate, ammonium nitrate, urea, ammonium chloride, and calcium carbonate. Also, organic fine powders such as wheat flour, wheat bran, and rice bran may be used. The liquid carriers include vegetable oils such as soybean oil and cottonseed oil, glycerol, ethylene glycol, polyethylene glycol, propylene glycol, polypropylene glycol, etc.

According to some embodiments, the agricultural composition can be a field ready spray or a tank mix.

According to an aspect of some embodiments of the invention, there is provided a method inhibiting growth of a photosynthetic organism, the method comprising contacting the photosynthetic organism with a combination of an effective amount of the compound depicted by Formula A, I or II and an effective amount of a herbicide, wherein the herbicide inhibits activity of 5-enolpyruvyl-shikimate synthetase (EPSPS) in the photosynthetic organism, thereby inhibiting the growth of the photosynthetic organism.

Thus, the method of this aspect of the invention can significantly reduce the levels (e.g., amount, concentration) of the herbicide (e.g., glyphosate) when applied together with phenylalanine-based structural analogues of some embodiments of the invention (Formulas A, I and II).

It should be noted that when phenylalanine-based structural analogues were added to the formulation of herbicides, the glyphosate resistant plants became sensitive again (FIG. 9).

According to some embodiments of the invention, the effective amount of the compound depicted by Formula A, I or II is provided prior to or concomitantly with the effective amount of the herbicide.

According to some embodiments of the invention, the effective amount of the herbicide is reduced by at least 1%, 2%, 3%, 4%, 5%, at least about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, e.g., by 97%, 98%, 99% as compared to an amount of the herbicide required for achieving the same growth inhibition of the photosynthetic organism when administered in the absence of the effective amount of the compound depicted by Formula A, I or II.

According to some embodiments of the invention, the herbicide is glyphosate.

According to some embodiments of the invention, the amount of glyphosate required for achieving the same growth inhibition of a weed as in the absence of the compound depicted by Formula A, I or II is reduced by at least about 10%, e.g., by at least about 20%, e.g., by at least about 30%, e.g., by at least about 40%, e.g., by at least about 50%, e.g., by at least about 60%, e.g., by at least about 70%, e.g., by at least about 80%, e.g., by at least 90% or more when used in combination with the effective amount of the compound depicted by Formula A, I or II.

For example, when inhibition of weed growth (e.g., A. thaliana) is achieved using an amount of 100 μM of glyphosate (based on TAIR database) when used in the absence of the effective amount of the compound depicted by Formula A, I or II, the concentration of glyphosate required for achieving the same growth inhibition of the weed in the presence of the effective amount of the compound depicted by Formula A, I or II is 10 μM of glyphosate, i.e., a reduction of about 90% in the concentration of glyphosate (e.g., using the ZYX1 compound as shown in FIG. 9).

According to some embodiments of the invention, the compound is represented by Formula I as defined herein.

According to some embodiments of the invention, the compound is represented by Formula II as defined herein.

According to some embodiments of the invention, the photosynthetic organism is a plant.

According to some embodiments of the invention, the plant comprises an angiosperm.

According to some embodiments of the invention, the plant comprises a weed or a weed seed.

According to some embodiments of the invention, the photosynthetic organism is a photosynthetic bacterium.

According to some embodiments of the invention, the photosynthetic bacterium comprises cyanobacterium.

The present inventors have further uncovered a method of selective growth of plants which over-express aminoacyl tRNA synthetase (aaRS) such as phenylalanyl-tRNA synthetase (PheRS) in the presence of an effective amount of a compound depicted by Formula I in order to provide these plants an advantage over other plants which do not over-express the aminoacyl tRNA synthetase (aaRS), such as unwanted plant species, e.g., weeds.

Thus, according to an aspect of some embodiments of the invention there is provided a method of growing a plant, comprising:
growing a plant over-expressing an aminoacyl tRNA synthetase (aaRS) as compared to an expression level of said aaRS in a wild type plant of the same species in the presence of an effective amount of a compound depicted by Formula I, wherein the effective amount of the compound depicted by Formula I is capable of inhibiting growth of the wild type plant of the same species under the same growth conditions, thereby growing the plant.

According to some embodiments of the invention, the plant is a crop plant or an ornamental plant.

According to some embodiments of the invention, the plant is a crop plant.

According to some embodiments of the invention, the plant is an ornamental plant.

According to the method of some embodiments of the invention, the effective amount of the compound depicted by Formula I is unable to inhibit the growth of the plant over-expressing the aaRS.

According to the method of some embodiments of the invention, the effective amount of the compound depicted by Formula I inhibits the growth of unwanted plants, such as weeds, which do not over express the aaRS, under the same growth conditions.

Thus, by over-expressing the aaRS within the plant such plants are resistance to growth inhibition by the compound depicted by Formula I, while other plants, e.g., wild type plants, native plants not modified to over-express the aaRS are sensitive to the compound depicted by Formula I and accordingly their growth is inhibited.

According to some embodiments of the invention, the inhibition of the growth of the wild type plant (e.g., a crop plant or an ornamental plant) is shown by at least one of reduced root length, reduced root radical, reduced root mass, reduced plant height, aberrant change in a plant tissue morphology or color, reduced plant shoot mass, reduced plant shoot number and any combination thereof.

The phrase “over-expressing an aminoacyl tRNA synthetase (aaRS)” as used herein refers to a plant having increased level of the aminoacyl tRNA synthetase polypeptide as compared to a control plant of the same species under the same growth conditions.

According to some embodiments of the invention the increased level of the aminoacyl tRNA synthetase polypeptide is in a specific cell type or organ of the plant.

According to some embodiments of the invention, the increased level of the aminoacyl tRNA synthetase polypeptide is in a temporal time point of the plant.

According to some embodiments of the invention, the increased level of the aminoacyl tRNA synthetase polypeptide is during the whole life cycle of the plant.

For example, over-expression of the aminoacyl tRNA synthetase polypeptide can be achieved by elevating the expression level of a native gene of a plant as compared to a control plant. This can be done for example, by means of genome editing which are well known in the art, e.g., by introducing mutation(s) in regulatory element(s) (e.g., an enhancer, a promoter, an untranslated region, an intronic region) which result in upregulation of the native gene, and/or by Homology Directed Repair (HDR), e.g., for introducing a “repair template” encoding the polypeptide-of-interest (aminoacyl tRNA synthetase).

Additionally and/or alternatively, over-expression of the aminoacyl tRNA synthetase polypeptide can be achieved by increasing a level of the aminoacyl tRNA synthetase due to expression of a heterologous polynucleotide by means of recombinant DNA technology, e.g., using a nucleic acid construct comprising a polynucleotide encoding the aminoacyl tRNA synthetase.

It should be noted that in case the plant-of-interest (e.g., a plant for which over-expression of the aminoacyl tRNA synthetase is desired) has no detectable expression level of the aminoacyl tRNA synthetase prior to employing the method of some embodiments of the invention, qualifying an “over-expression” of the aminoacyl tRNA synthetase in the plant is performed by determination of a positive detectable expression level of the aminoacyl tRNA synthetase in a plant cell and/or a plant.

Additionally and/or alternatively in case the plant-of-interest (e.g., a plant for which over-expression of the aminoacyl tRNA synthetase is desired) has some degree of detectable expression level of the aminoacyl tRNA synthetase prior to employing the method of some embodiments of the invention, qualifying an “over-expression” of the aminoacyl tRNA synthetase in the plant is performed by determination of an increased level of expression of the aminoacyl tRNA synthetase in a plant cell and/or a plant as compared to a control plant cell and/or plant, respectively, of the same species which is grown under the same (e.g., identical) growth conditions.

Methods of detecting presence or absence of a polypeptide in a plant cell and/or in a plant, as well as quantification of protein expression levels are well known in the art (e.g., protein detection methods) such as, activity assays, Western blots using antibodies capable of specifically binding the polypeptide, Enzyme-Linked Immuno Sorbent Assay (ELISA), radio-immuno-assays (RIA), immunohistochemistry, immunocytochemistry, immunofluorescence and the like.

According to some embodiments of the invention, the aaRS is phenylalanyl-tRNA synthetase (PheRS).

According to some embodiments of the invention, the PheRS is a heterotetrameric bacterial PheRS composed of two PheRS-α and two PheRS-β strands.

According to some embodiments of the invention, the bacterial PheRS is selected from the group consisting of Escherichia coli (E. coli) PheRS, Thermus thermophilus PheRS and other class II bacterial PheRSs with (αβ)₂ quaternary organization in view of their close sequence and structural similarity.

According to some embodiments of the invention, the E. Coli PheRS-α is encoded by a polynucleotide having the nucleic acid sequence set forth in SEQ ID NO: 1 and the E. Coli PheRS-β is encoded by a polynucleotide having the nucleic acid sequence set forth in SEQ ID NO:2.

According to some embodiments of the invention, the E. Coli PheRS-α comprises the amino acid sequence set forth in SEQ ID NO:3 and the E. Coli PheRS-β comprises the amino acid sequence set forth in SEQ ID NO:4.

According to some embodiments of the invention, the T. thermophilus PheRS-α comprises the amino acid sequence set forth in SEQ ID NO:5 and the T. thermophilus PheRS-β² comprises the amino acid sequence set forth in SEQ ID NO:6.

According to some embodiments of the invention, the aminoacyl tRNA synthetase (aaRS) is encoded by a polynucleotide which further comprises a nucleic acid sequence encoding a targeting peptide selected from the group consisting of a mitochondrial targeting peptide and a chloroplast targeting peptide.

According to certain embodiments, the polynucleotide encoding the aaRS or a fragment thereof comprising the editing module further comprises a nucleic acid sequence encoding a targeting peptide selected from the group consisting of a mitochondrial targeting peptide and a chloroplast targeting peptide. The mitochondrial and chloroplast targeting peptides can be the same or different. Typically, the polynucleotide is so designed that the encoded targeting peptide is fused at the amino terminus (N-terminus) of the encoded aaRS polypeptide. According to certain embodiments, the transgenic plant comprises a combination of the exogenous polynucleotide encoding the aminoacyl tRNA synthetase (aaRS) or a fragment thereof further comprising the nucleic acid sequence encoding the mitochondrial targeting peptide and the exogenous polynucleotide encoding the aaRS or a fragment thereof further comprising the nucleic acid sequence encoding a chloroplast targeting peptide.

According to certain embodiments, the mitochondrial and the chloroplast targeting peptides are encoded by the nucleic acid sequence set forth in SEQ ID NO: 7 and have the amino acid sequence set forth in SEQ ID NO:8. According to yet other embodiments, the polynucleotides of the present invention are incorporated in a DNA construct (nucleic acid construct) enabling their expression in a host cell (e.g., the plant cell). According to one embodiment, the DNA construct comprises at least one expression regulating element selected from the group consisting of a promoter, an enhancer, an origin of replication, a transcription termination sequence, a polyadenylation signal and the like. According to some embodiments, the DNA construct comprises a promoter. The promoter can be constitutive, induced or tissue specific promoter (e.g., a root specific promoter) as is known in the art. According to further embodiments, the DNA construct further comprises transcription termination and polyadenylation sequence signals.

According to some embodiments of the invention the promoter is heterologous to the isolated polynucleotide encoding the aminoacyl tRNA synthetase (aaRS) or a fragment thereof comprising an editing module.

According to some embodiments of the invention the promoter is heterologous to the host cell (e.g., the plant cell) used for transformation of the nucleic acid construct.

Optionally, the DNA construct further comprises a nucleic acid sequence encoding a detection marker enabling a convenient selection of the transgenic plant. According to certain embodiments, the detection marker is selected from the group consisting of a polynucleotide encoding a protein conferring resistance to antibiotic; a polynucleotide encoding a protein conferring resistance to herbicide and a combination thereof.

The present invention also encompasses seeds of the transgenic plant, wherein plants grown from said seeds are resistant to the compound depicted by Formula II as described herein. The present invention further encompasses fruit, leaves or any part of the transgenic plant, as well as tissue cultures derived thereof and plants regenerated therefrom.

According to some embodiments of the invention, the plants over-expressing the aminoacyl tRNA synthetase are produced by transforming a plant cell with at least one exogenous polynucleotide encoding the aminoacyl tRNA synthetase (aaRS) or a fragment thereof comprising an editing module, the editing module capable of hydrolyzing non-protein aminoacylated tRNA; and (b) regenerating the transformed cell into a transgenic plant resistant to the compound depicted by Formula I.

The exogenous polynucleotide(s) encoding the aminoacyl tRNA synthetase (aaRS) or a fragment thereof comprising the editing module, capable of hydrolyzing non-protein aminoacylated tRNA according to the teachings of the present invention can be introduced into a DNA construct to include the entire elements necessary for transcription and translation as described above, such that the polypeptides are expressed within the plant cell.

Transformation of plants with a polynucleotide or a DNA construct may be performed by various means, as is known to one skilled in the art. Common methods are exemplified by, but are not restricted to, Agrobacterium-mediated transformation, microprojectile bombardment, pollen mediated transfer, plant RNA virus mediated transformation, liposome mediated transformation, direct gene transfer (e.g. by microinjection) and electroporation of compact embryogenic calli. According to one embodiment, the transgenic plants of the present invention are produced using Agrobacterium mediated transformation.

Transgenic plants comprising the exogenous polynucleotides encoding aaRS or a fragment thereof comprising the editing module according to the teachings of the present invention may be selected employing standard methods of molecular genetics, as are known to a person of ordinary skill in the art. According to certain embodiments, the transgenic plants are selected according to their resistance to an antibiotic or herbicide. According to one embodiment, the antibiotic serving as a selectable marker is one of the group consisting of cefotaxime, vancomycin and kanamycin. According to another embodiment, the herbicide serving as a selectable marker is the non-selective herbicide glufosinate-ammonium (BASTA®).

According to yet other embodiments, the transgenic plants of the invention are selected based on their resistance to the compound depicted by Formula I.

Any plant can be transformed with the polynucleotides of the present invention to produce the transgenic plants resistant to the presence of the compound depicted by Formula I in the plant growth medium.

The compounds represented by Formulae I and II as described herein are collectively referred to as phenylalanine structural analogues.

Compound represented by Formula II are also referred to herein meta-tyrosine or meta-tyrosine analogues.

Phenylalanine structural analogues as described herein can be collectively represented by the following general Formula A:

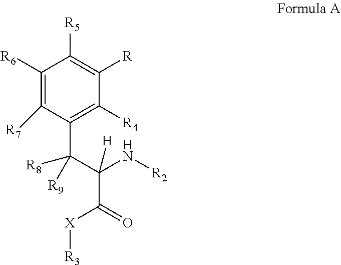

wherein:
R can be R₁, as defined herein, or OR₁₀, as defined herein;
R₂ is selected from H, sulfonate, sulfonamide, phosphonate, alkyl, alkenyl, alkynyl, alkoxy, carboxy, saccharide, cycloalkyl, heterocycloalkyl, aryl, and heteroaryl, wherein each of the phosphonate, alkyl, alkenyl, alkynyl, alkoxy, alkoxycarbonyl, saccharide, cycloalkyl, heterocycloalkyl, aryl, and heteroaryl is either substituted or unsubstituted;
R₃ is selected from H, alkyl, alkenyl, alkynyl, alkoxy, carboxy, saccharide, cycloalkyl, heterocycloalkyl, aryl, and heteroaryl, wherein each of the alkyl, alkenyl, alkynyl, alkoxy, carboxy, saccharide, cycloalkyl, heterocycloalkyl, aryl, and heteroaryl is either substituted or unsubstituted;
X is selected from the group consisting of O and N—Z, wherein Z is selected from the group consisting of H, alkyl, alkenyl, alkynyl, alkoxy, carboxy, saccharide, cycloalkyl, heterocycloalkyl, aryl, and heteroaryl, wherein each of the alkyl, alkenyl, alkynyl, alkoxy, alkoxycarbonyl, saccharide, cycloalkyl, heterocycloalkyl, aryl, and heteroaryl is either substituted or unsubstituted;
R₄, R₅, R₆, and R₇ are each independently selected from H, hydroxyl, halogen, amino, and nitro; and
R₈ and R₉ are independently selected from H, hydroxyl, halogen, amino, alkyl, and haloalkyl.

When R is R₁, the compounds are represented by Formula I as described herein.

For compounds of Formula I, R₁ can be any substituent excepting oxygen-containing substituents or moieties in which the oxygen atom is linked directly to the ring carbon, such as, for example, hydroxy, alkoxy, aryloxy, O-carboxy. Oxygen-containing substituents in which the oxygen atom is not linked directly to the ring carbon are not excluded. In some embodiments, R₁ in Formula I is selected from alkyl (e.g., a short alkyl, preferably unsubstituted, such as methyl, ethyl, propyl, isopropyl, isobutyl or tert-butyl), alkenyl (e.g., —CH═CH₂), alkynyl (e.g., athynyl; —C≡CH), hydroxyalkyl (e.g., hydroxymethyl), aminoalkyl (e.g., aminomethyl), haloalkyl (e.g., trihaloalkyl such as CF₃), halogen (e.g., fluoro, iodo, bromo or iodo), nitro, cyano, amino (e.g., NH₂), amidino, thiol, carboxy, and borate.

According to some embodiments of the invention, R₁ in Formula I is selected from CH₃, CF₃, F, CN, Cl, Br, I, —NO₂, —CH₂CH₃, —NH₂, —SH, ethynyl (—C≡CH), —CH(CH₃)₂, —CH₂OH, —CH₂NH₂, —B(OH)₂, —C(CH₃)₃, or —C(═O)OH. In some embodiments, R₁ in Formula I is alkyl, for example, methyl. Other alkyls, preferably short alkyls, of 1-6, or of 1-4, carbon atoms in length, which can be linear or branched, are contemplated.

In some embodiments, R₁ is a haloalkyl, and in some embodiments, it is a trihaloalkyl, such as trihalomethyl. Other haloalkyls, preferably short alkyls, of 1-6, or of 1-4, carbon atoms in length, including 1, 2, 3 or more halogen substituents, are contemplated.

In some embodiments, the haloalkyl is trihalomethyl, and in some embodiments, it is trifluoromethyl, CF₃.

In some embodiments, R₁ in Formula I is halogen, for example, fluoro, chloro, bromo or iodo.

In some embodiments, R₁ in Formula I is fluoro.

When R is OR₁₀, the compounds are represented by Formula II as described herein, and are referred to also as meta-tyrosine or analogues thereof.

In Formula II, R₁₀ can be, for example, H, sulfonate, sulfonamide, phosphonate, alkyl, alkenyl, alkynyl, alkoxy, carboxy, saccharide, cycloalkyl, heterocycloalkyl, aryl, and heteroaryl, wherein each of the phosphonate, alkyl, alkenyl, alkynyl, alkoxy, alkoxycarbonyl, saccharide, cycloalkyl, heterocycloalkyl, aryl, and heteroaryl is either substituted or unsubstituted, as defined herein.

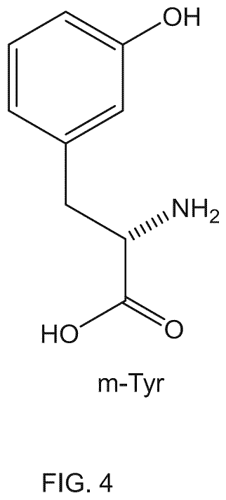

In some embodiments, R₁₀ is H and the compound is meta-tyrosine, as depicted in FIG. 4.

In some of any of the embodiments described herein, X is O. In some embodiments R₃ is H, such that the compound features a carboxylic acid.

In some of any of the embodiments described herein, R₂ is H such that the compound features an amine and is an analog of an amino acid.

In some of any of the embodiments described herein, R₄-R₇ are each hydrogen, although any other substituents are also contemplated.

In some of any of the embodiments described herein, R₈ and R₉ are each hydrogen.

For any of the embodiments described herein, and any combination thereof, the compound may be in a form of a salt, for example, an agriculturally acceptable salt.

As used herein, the phrase “agriculturally acceptable salt” refers to a charged species of the parent compound and its counter-ion, which is typically used to modify the solubility characteristics of the parent compound and/or to reduce any significant irritation to a plant by the parent compound, while not abrogating the biological activity and properties of the administered compound. A salt of a compound as described herein can alternatively be formed during the synthesis of the compound, e.g., in the course of isolating the compound from a reaction mixture or re-crystallizing the compound.

In the context of some of the present embodiments, a salt of the compounds described herein may optionally be an acid addition salt comprising at least one basic (e.g., amine and/or guanidine) group of the compound which is in a positively charged form (e.g., wherein the basic group is protonated), in combination with at least one counter-ion, derived from the selected base, that forms a salt.

Alternatively, a salt of the compounds described herein may optionally comprise at least one acidic (e.g., hydroxy, carboxylic acid) group of the compound which is in a negatively charged form (e.g., wherein the group is deprotonated), in combination with at least one counter-ion, typically a metal catio, that forms a salt.

Depending on the stoichiometric proportions between the charged group(s) in the compound and the counter-ion in the salt, the acid additions salts can be either mono-addition salts or poly-addition salts.

The phrase “mono-addition salt”, as used herein, refers to a salt in which the stoichiometric ratio between the counter-ion and charged form of the compound is 1:1, such that the addition salt includes one molar equivalent of the counter-ion per one molar equivalent of the compound.

The phrase “poly-addition salt”, as used herein, refers to a salt in which the stoichiometric ratio between the counter-ion and the charged form of the compound is greater than 1:1 and is, for example, 2:1, 3:1, 4:1 and so on, such that the addition salt includes two or more molar equivalents of the counter-ion per one molar equivalent of the compound.

The acid addition salts of the compounds described herein may therefore be complexes formed between one or more basic groups of the compound and one or more equivalents of an acid.

An example, without limitation, of a pharmaceutically acceptable salt would be an ammonium cation or guanidinium cation and an acid addition salt thereof.

The acid addition salts may include a variety of organic and inorganic acids, such as, but not limited to, hydrochloric acid which affords a hydrochloric acid addition salt, hydrobromic acid which affords a hydrobromic acid addition salt, acetic acid which affords an acetic acid addition salt, ascorbic acid which affords an ascorbic acid addition salt, benzenesulfonic acid which affords a besylate addition salt, camphorsulfonic acid which affords a camphorsulfonic acid addition salt, citric acid which affords a citric acid addition salt, maleic acid which affords a maleic acid addition salt, malic acid which affords a malic acid addition salt, methanesulfonic acid which affords a methanesulfonic acid (mesylate) addition salt, naphthalenesulfonic acid which affords a naphthalenesulfonic acid addition salt, oxalic acid which affords an oxalic acid addition salt, phosphoric acid which affords a phosphoric acid addition salt, toluenesulfonic acid which affords a p-toluenesulfonic acid addition salt, succinic acid which affords a succinic acid addition salt, sulfuric acid which affords a sulfuric acid addition salt, tartaric acid which affords a tartaric acid addition salt and trifluoroacetic acid which affords a trifluoroacetic acid addition salt. Each of these acid addition salts can be either a mono-addition salt or a poly-addition salt, as these terms are defined herein.

The present embodiments further encompass any enantiomers, diastereomers, solvates, and/or hydrates of the compounds described herein.

As used herein, the term “enantiomer” refers to a stereoisomer of a compound that is superposable with respect to its counterpart only by a complete inversion/reflection (mirror image) of each other. Enantiomers are the to have “handedness” since they refer to each other like the right and left hand. Enantiomers have identical chemical and physical properties except when present in an environment which by itself has handedness, such as all living systems. In the context of the present embodiments, a compound may exhibit one or more chiral centers, each of which exhibiting an R- or an S-configuration and any combination, and compounds according to some embodiments of the present invention, can have any their chiral centers exhibit an R- or an S-configuration.

The term “diastereomers”, as used herein, refers to stereoisomers that are not enantiomers to one another. Diastereomerism occurs when two or more stereoisomers of a compound have different configurations at one or more, but not all of the equivalent (related) stereocenters and are not mirror images of each other. When two diastereoisomers differ from each other at only one stereocenter they are epimers. Each stereo-center (chiral center) gives rise to two different configurations and thus to two different stereoisomers. In the context of the present invention, embodiments of the present invention encompass compounds with multiple chiral centers that occur in any combination of stereo-configuration, namely any diastereomer.

The term “solvate” refers to a complex of variable stoichiometry (e.g., di-, tri-, tetra-, penta-, hexa-, and so on), which is formed by a solute (the compound of the present invention) and a solvent, whereby the solvent does not interfere with the biological activity of the solute. Suitable solvents include, for example, ethanol, acetic acid and the like.

The term “hydrate” refers to a solvate, as defined hereinabove, where the solvent is water.

The terms “hydroxyl” or “hydroxy”, as used herein, refer to an —OH group.

As used herein, the term “amine” describes a —NR′R″ group where each of R′ and R″ is independently hydrogen, alkyl, alkenyl, alkynyl, cycloalkyl, heteroalicyclic, aryl, heteroaryl, alkaryl, alkheteroaryl, or acyl, as these terms are defined herein. Alternatively, one or both of R′ and R″ can be, for example, hydroxy, alkoxy, hydroxyalkyl, trihaloalkyl, cycloalkyl, alkenyl, alkynyl, aryl, heteroaryl, heteroalicyclic, amine, halide, sulfonate, sulfoxide, phosphonate, hydroxy, alkoxy, aryloxy, thiohydroxy, thioalkoxy, thioaryloxy, cyano, nitro, azo, sulfonamide, carbonyl, C-carboxylate, O-carboxylate, N-thiocarbamate, 0-thiocarbamate, urea, thiourea, N-carbamate, 0-carbamate, C-amide, N-amide, guanyl, guanidine and hydrazine.

The term “amine” also describes a —NR′-linking group (a biradical group, attached to two moieties), with R′ as described herein.

As used herein, the term “alkyl” describes an aliphatic hydrocarbon including straight chain and branched chain groups. The alkyl may have 1 to 20 carbon atoms, or 1-10 carbon atoms, and may be branched or unbranched. Whenever a numerical range; e.g., “1-10”, is stated herein, it implies that the group, in this case the alkyl group, may contain 1 carbon atom, 2 carbon atoms, 3 carbon atoms, etc., up to and including 10 carbon atoms. In some embodiments, the alkyl is a lower alkyl, including 1-6 or 1-4 carbon atoms.

An alkyl can be substituted or unsubstituted. When substituted, the substituent can be, for example, one or more of an alkyl (forming a branched alkyl), an alkenyl, an alkynyl, a cycloalkyl, an aryl, a heteroaryl, a heteroalicyclic, a halo, a trihaloalkyl, a hydroxy, an alkoxy and a hydroxyalkyl as these terms are defined hereinbelow. An alkyl substituted by aryl is also referred to herein as “alkaryl”, an example of which is benzyl. The alkyl can be substituted by other substituents, as described hereinbelow.

The term “alkenyl” describes an unsaturated alkyl, as defined herein, having at least two carbon atoms and at least one carbon-carbon double bond, e.g., allyl, vinyl, 3-butenyl, 2-butenyl, 2-hexenyl and i-propenyl. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” refers to an all-carbon monocyclic or fused ring (i.e., rings which share an adjacent pair of carbon atoms), branched or unbranched group containing 3 or more carbon atoms where one or more of the rings does not have a completely conjugated pi-electron system, and may further be substituted or unsubstituted. Exemplary cycloalkyl groups include, for example, cyclopropyl, cyclobutyl, cyclopentyl, cyclohexyl, or cyclododecyl. The cycloalkyl can be substituted or unsubstituted.

The term “aryl” describes an all-carbon monocyclic or fused-ring polycyclic (i.e., rings which share adjacent pairs of carbon atoms) groups having a completely conjugated pi-electron system. The aryl group may be unsubstituted or substituted by one or more substituents. An aryl substituted by alkyl is also referred to herein as “aralkyl”, as example of which is toluyl.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. Representative examples are thiadiazole, pyridine, pyrrole, oxazole, indole, purine and the like. The heteroaryl group may be unsubstituted or substituted by one or more substituents.

The term “heteroalicyclic”, as used herein, describes a monocyclic or fused ring group having in the ring(s) one or more atoms such as nitrogen, oxygen and sulfur. The rings may also have one or more double bonds. However, the rings do not have a completely conjugated pi-electron system. Representative examples are morpholine, piperidine, piperazine, tetrahydrofurane, tetrahydropyrane and the like. The heteroalicyclic may be substituted or unsubstituted.

The term “halo” or “halogen” refers to F, Cl, Br and I atoms as substituents.

The term “alkoxy” refers to an —OR′ group, wherein R′ is alkyl or cycloalkyl, as defined herein.

The term “aryloxy” refers to an —OR′ group, wherein R′ is aryl, as defined herein.

The term “heteroaryloxy” refers to an —OR′ group, wherein R′ is heteroaryl, as defined herein.

The term “thioalkoxy” refers to an —SR′ group, wherein R′ is alkyl or cycloalkyl, as defined herein.

The term “thioaryloxy” refers to an —SR′ group, wherein R′ is aryl, as defined herein.

The term “thioheteroaryloxy” refers to an —SR′ group, wherein R′ is heteroaryl, as defined herein.

The term “hydroxyalkyl,” as used herein, refers to an alkyl group, as defined herein, substituted with one or more hydroxy group(s), e.g., hydroxymethyl, 2-hydroxyethyl and 4-hydroxypentyl.

The term “aminoalkyl,” as used herein, refers to an alkyl group, as defined herein, substituted with one or more amino group(s).

The term “alkoxyalkyl,” as used herein, refers to an alkyl group substituted with one or more alkoxy group(s), e.g., methoxymethyl, 2-methoxyethyl, 4-ethoxybutyl, n-propoxyethyl and t-butylethyl.

The term “trihaloalkyl” refers to —CQ₃, wherein Q is halo, as defined herein. An exemplary haloalkyl is CF₃.

A “guanidino” or “guanidine” or “guanidinyl” or “guanidyl” group refers to an —RaNC(=NRd)—NRbRc group, where each of Ra, Rb, Rc and Rd can each be as defined herein for R′ and R″.

A “guanyl” or “guanine” group refers to an RaRbNC(=NRd)— group, where Ra, Rb and Rd are each as defined herein for R′ and R″.

Whenever an alkyl, cycloalkyl, aryl, alkaryl, heteroaryl, heteroalicyclic, acyl and any other moiety or group as described herein is substituted, it includes one or more substituents, each can independently be, but are not limited to, hydroxy, alkoxy, thiohydroxy, thioalkoxy, aryloxy, thioaryloxy, alkaryl, alkyl, alkenyl, alkynyl, sulfonate, sulfoxide, thiosulfate, sulfate, sulfite, thiosulfite, phosphonate, cyano, nitro, azo, sulfonamide, carbonyl, thiocarbonyl, C-carboxylate, O-carboxylate, N-thiocarbamate, 0-thiocarbamate, oxo, thiooxo, oxime, acyl, acyl halide, azo, azide, urea, thiourea, N-carbamate, 0-carbamate, C-amide, N-amide, guanyl, guanidyl, hydrazine and hydrazide, as these terms are defined herein. Similarly, any R′ and R″ as described herein, can be any of the substituents described herein, when chemically compatible.

The term “cyano” describes a —C≡N group.

The term “nitro” describes an —NO₂ group.

The term “amidine” describes a —NH—CH(═NH) group or —NR′—CR″′(═NR″) or NR′R″—CR″′(═NRa)— group, with R′ and R″ as described herein, and R″′ and Ra as described herein for R′ and R″.

The term “sulfate” describes a —O—S(═O)₂—OR′ end group, as this term is defined hereinabove, or an —O—S(═O)₂—O-linking group, as these phrases are defined hereinabove, where R′ is as defined hereinabove.

The term “thiosulfate” describes a —O—S(═S)(═O)—OR′ end group or a —O—S(═S)(═O)—O-linking group, as these phrases are defined hereinabove, where R′ is as defined hereinabove.

The term “sulfite” describes an —O—S(═O)—O—R′ end group or a —O—S(═O)—O—group linking group, as these phrases are defined hereinabove, where R′ is as defined hereinabove.

The term “thiosulfite” describes a —O—S(═S)—O—R′ end group or an —O—S(═S)-0-group linking group, as these phrases are defined hereinabove, where R′ is as defined hereinabove.

The term “sulfinate” describes a —S(═O)—OR′ end group or an —S(═O)—O-group linking group, as these phrases are defined hereinabove, where R′ is as defined hereinabove.

The term “sulfoxide” or “sulfinyl” describes a —S(═O)R′ end group or an —S(═O)— linking group, as these phrases are defined hereinabove, where R′ is as defined hereinabove.

The term “sulfonate” or “sulfonyl” describes a —S(═O)₂—R′ end group or an —S(═O)₂-linking group, as these phrases are defined hereinabove, where R′ is as defined herein.

The term “S-sulfonamide” describes a —S(═O)₂—NR′R″ end group or a —S(═O)₂—NR′-linking group, as these phrases are defined hereinabove, with R′ and R″ as defined herein.

The term “N-sulfonamide” describes an R'S(═O)₂—NR″— end group or a —S(═O)₂—NR′-linking group, as these phrases are defined hereinabove, where R′ and R″ are as defined herein.

The term “carbonyl” or “carbonate” as used herein, describes a —C(═O)—R′ end group or a —C(═O)-linking group, as these phrases are defined hereinabove, with R′ as defined herein.

The term “thiocarbonyl” as used herein, describes a —C(═S)—R′ end group or a —C(═S)-linking group, as these phrases are defined hereinabove, with R′ as defined herein.

The term “oxo” as used herein, describes a (═O) group, wherein an oxygen atom is linked by a double bond to the atom (e.g., carbon atom) at the indicated position.

The term “thiooxo” as used herein, describes a (═S) group, wherein a sulfur atom is linked by a double bond to the atom (e.g., carbon atom) at the indicated position.

The term “oxime” describes a ═N—OH end group or a ═N—O-linking group, as these phrases are defined hereinabove.

The term “acyl halide” describes a —(C═O)R″″ group wherein R″″ is halo, as defined hereinabove.

The term “azo” or “diazo” describes an —N═NR′ end group or an —N═N-linking group, as these phrases are defined hereinabove, with R′ as defined hereinabove.

The term “azide” describes an —N₃ end group.

The term “carboxylate” as used herein encompasses C-carboxylate and O-carboxylate.

The term “C-carboxylate” describes a —C(═O)—OR′ end group or a —C(═O)—O—linking group, as these phrases are defined hereinabove, where R′ is as defined herein.

The term “O-carboxylate” describes a —OC(═O)R′ end group or a —OC(═O)— linking group, as these phrases are defined hereinabove, where R′ is as defined herein.

A carboxylate can be linear or cyclic. When cyclic, R′ and the carbon atom are linked together to form a ring, in C-carboxylate, and this group is also referred to as lactone. Alternatively, R′ and O are linked together to form a ring in O-carboxylate. Cyclic carboxylates can function as a linking group, for example, when an atom in the formed ring is linked to another group.

The term “thiocarboxylate” as used herein encompasses C-thiocarboxylate and O-thiocarboxylate.

The term “C-thiocarboxylate” describes a —C(═S)—OR′ end group or a —C(═S)—O—linking group, as these phrases are defined hereinabove, where R′ is as defined herein.

The term “O-thiocarboxylate” describes a —OC(═S)R′ end group or a —OC(═S)— linking group, as these phrases are defined hereinabove, where R′ is as defined herein.

A thiocarboxylate can be linear or cyclic. When cyclic, R′ and the carbon atom are linked together to form a ring, in C-thiocarboxylate, and this group is also referred to as thiolactone. Alternatively, R′ and O are linked together to form a ring in O-thiocarboxylate. Cyclic thiocarboxylates can function as a linking group, for example, when an atom in the formed ring is linked to another group.

The term “carbamate” as used herein encompasses N-carbamate and O-carbamate.

The term “N-carbamate” describes an R″OC(═O)—NR′— end group or a —OC(═O)—NR′-linking group, as these phrases are defined hereinabove, with R′ and R″ as defined herein.

The term “O-carbamate” describes an —OC(═O)—NR′R″ end group or an —OC(═O)—NR′-linking group, as these phrases are defined hereinabove, with R′ and R″ as defined herein.

A carbamate can be linear or cyclic. When cyclic, R′ and the carbon atom are linked together to form a ring, in O-carbamate. Alternatively, R′ and O are linked together to form a ring in N-carbamate. Cyclic carbamates can function as a linking group, for example, when an atom in the formed ring is linked to another group.

The term “carbamate” as used herein encompasses N-carbamate and O-carbamate.

The term “thiocarbamate” as used herein encompasses N-thiocarbamate and O-thiocarbamate.

The term “O-thiocarbamate” describes a —OC(═S)—NR′R″ end group or a —OC(═S)—NR′-linking group, as these phrases are defined hereinabove, with R′ and R″ as defined herein.

The term “N-thiocarbamate” describes an R″OC(═S)NR′— end group or a —OC(═S)NR′-linking group, as these phrases are defined hereinabove, with R′ and R″ as defined herein.

Thiocarbamates can be linear or cyclic, as described herein for carbamates.

The term “dithiocarbamate” as used herein encompasses S-dithiocarbamate and N-dithiocarbamate.

The term “S-dithiocarbamate” describes a —SC(═S)—NR′R″ end group or a —SC(═S)NR′-linking group, as these phrases are defined hereinabove, with R′ and R″ as defined herein.

The term “N-dithiocarbamate” describes an R″SC(═S)NR′— end group or a —SC(═S)NR′-linking group, as these phrases are defined hereinabove, with R′ and R″ as defined herein.

The term “urea”, which is also referred to herein as “ureido”, describes a —NR′C(═O)—NR″R″′ end group or a —NR′C(═O)—NR″-linking group, as these phrases are defined hereinabove, where R′ and R″ are as defined herein and R″′ is as defined herein for R′ and R″.

The term “thiourea”, which is also referred to herein as “thioureido”, describes a —NR′—C(═S)—NR″R″′ end group or a —NR′—C(═S)—NR″-linking group, with R′, R″ and R″′ as defined herein.

The term “amide” as used herein encompasses C-amide and N-amide.

The term “C-amide” describes a —C(═O)—NR′R″ end group or a —C(═O)—NR′— linking group, as these phrases are defined hereinabove, where R′ and R″ are as defined herein.

The term “N-amide” describes a R′C(═O)—NR″— end group or a R′C(═O)—N— linking group, as these phrases are defined hereinabove, where R′ and R″ are as defined herein.

The term “hydrazine” describes a —NR′—NR″R″′ end group or a —NR′—NR″-linking group, as these phrases are defined hereinabove, with R′, R″, and R″′ as defined herein.

As used herein, the term “hydrazide” describes a —C(═O)—NR′—NR″R″′ end group or a —C(═O)—NR′—NR″-linking group, as these phrases are defined hereinabove, where R′, R″ and R″′ are as defined herein.

As used herein, the term “thiohydrazide” describes a —C(═S)—NR′—NR″R″′ end group or a —C(═S)—NR′—NR″-linking group, as these phrases are defined hereinabove, where R′, R″ and R″′ are as defined herein.

The term “boryl” describes a —BR′R″ end group or a —BR′-linking group, as these phrases are defined hereinabove, with R′ and R″ are as defined herein.

The term “borate” describes a —O—B(OR′)(OR″) end group or a —O—B(OR′)(O—) linking group, as these phrases are defined hereinabove, with R′ and R″ are as defined herein.

As used herein, the term “hydrazide” describes a —C(═O)—NR′—NR″R″′ end group or a —C(═O)—NR′—NR″-linking group, as these phrases are defined hereinabove, where R′, R″ and R″′ are as defined herein.

As used herein, the term “thiohydrazide” describes a —C(═S)—NR′—NR″R″′ end group or a —C(═S)—NR′—NR″-linking group, as these phrases are defined hereinabove, where R′, R″ and R″′ are as defined herein.

As used herein, the term “methyleneamine” describes an —NR′—CH₂—CH═CR″R′″ end group or a —NR′—CH₂—CH═CR″-linking group, as these phrases are defined hereinabove, where R′, R″ and R″′ are as defined herein.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

When reference is made to particular sequence listings, such reference is to be understood to also encompass sequences that substantially correspond to its complementary sequence as including minor sequence variations, resulting from, e.g., sequencing errors, cloning errors, or other alterations resulting in base substitution, base deletion or base addition, provided that the frequency of such variations is less than 1 in 50 nucleotides, alternatively, less than 1 in 100 nucleotides, alternatively, less than 1 in 200 nucleotides, alternatively, less than 1 in 500 nucleotides, alternatively, less than 1 in 1000 nucleotides, alternatively, less than 1 in 5,000 nucleotides, alternatively, less than 1 in 10,000 nucleotides.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Generally, the nomenclature used herein and the laboratory procedures utilized in the present invention include molecular, biochemical, microbiological and recombinant DNA techniques. Such techniques are thoroughly explained in the literature. See, for example, “Molecular Cloning: A laboratory Manual” Sambrook et al., (1989); “Current Protocols in Molecular Biology” Volumes I-III Ausubel, R. M., ed. (1994); Ausubel et al., “Current Protocols in Molecular Biology”, John Wiley and Sons, Baltimore, Maryland (1989); Perbal, “A Practical Guide to Molecular Cloning”, John Wiley & Sons, New York (1988); Watson et al., “Recombinant DNA”, Scientific American Books, New York; Birren et al. (eds) “Genome Analysis: A Laboratory Manual Series”, Vols. 1-4, Cold Spring Harbor Laboratory Press, New York (1998); methodologies as set forth in U.S. Pat. Nos. 4,666,828; 4,683,202; 4,801,531; 5,192,659 and 5,272,057; “Cell Biology: A Laboratory Handbook”, Volumes I-III Cellis, J. E., ed. (1994); “Current Protocols in Immunology” Volumes I-III Coligan J. E., ed. (1994); Stites et al. (eds), “Basic and Clinical Immunology” (8th Edition), Appleton & Lange, Norwalk, CT (1994); Mishell and Shiigi (eds), “Selected Methods in Cellular Immunology”, W. H. Freeman and Co., New York (1980); available immunoassays are extensively described in the patent and scientific literature, see, for example, U.S. Pat. Nos. 3,791,932; 3,839,153; 3,850,752; 3,850,578; 3,853,987; 3,867,517; 3,879,262; 3,901,654; 3,935,074; 3,984,533; 3,996,345; 4,034,074; 4,098,876; 4,879,219; 5,011,771 and 5,281,521; “Oligonucleotide Synthesis” Gait, M. J., ed. (1984); “Nucleic Acid Hybridization” Hames, B. D., and Higgins S. J., eds. (1985); “Transcription and Translation” Hames, B. D., and Higgins S. J., Eds. (1984); “Animal Cell Culture” Freshney, R. I., ed. (1986); “Immobilized Cells and Enzymes” IRL Press, (1986); “A Practical Guide to Molecular Cloning” Perbal, B., (1984) and “Methods in Enzymology” Vol. 1-317, Academic Press; “PCR Protocols: A Guide To Methods And Applications”, Academic Press, San Diego, C A (1990); Marshak et al., “Strategies for Protein Purification and Characterization—A Laboratory Course Manual” CSHL Press (1996); all of which are incorporated by reference as if fully set forth herein. Other general references are provided throughout this document. The procedures therein are believed to be well known in the art and are provided for the convenience of the reader. All the information contained therein is incorporated herein by reference.

### Example 1

### The Design of Phe-Derivatives as Highly Effective Herbicidal Agents

The present inventors have designed and generated analogues of phenylalanine, such as the Phe-analog compounds collectively represented by Formula I. It is noted that unlike meta-tyrosine which comprises an oxygen atom at the meta position (See Formula II), the phe-analogues or a salt thereof of some embodiments of the invention includes a non-oxygen atom at the meta-position (“R₁” in Formula I), wherein “R₁” can be, for example, CH₃, CF₃, F, CN, Cl, Br, I, NO₂, CH₂CH₃, NH₂, SH, CCH, CH₂(CH₃)₂, CH₂OH, CH₂NH₂, B(OH)₂, C(CH₃)₃, or CO(OH).

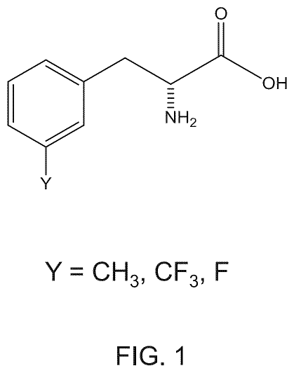

The structures of exemplary phenylalanine analogs are depicted in FIG. 1.

### Example 2

### Efficacy of the Phenylalanine-Analogue Compound on Germination of Arabidopsis Plants

Experimental Results

The germination of Arabidopsis thaliana plants is inhibited by the Phe-analogues of some embodiments of the invention—The efficiency of the developed compounds modified at the ‘meta’ position of the phenyl ring (FIG. 1) were analysed on Arabidopsis thaliana (var. Columbia). Following inhibition for 5 days at 4° C., Arabidopsis seeds were sown on Murashige-Skoog medium (MS) supplemented with increased concentrations (0-80 μM) of different Phe-analogues (in which “Y” was either “CH3”, “F” or “CF3”; see, FIG. 1). The data indicate that seed-germination was strongly affected by the presence of m-Tyr and three synthetic analogues, designated as “CH3”, “F” or “CF3” (FIGS. 2A-D). The present inventors also noticed that Arabidopsis seedlings treated with m-Tyr and the “CH3” and “F” Phe-analogues had white cotyledons and yellowish leaves, suggesting that the plants are defective in chloroplast development. Accordingly, microscopic analysis of Arabidopsis seedlings treated with 10 μM m-Tyr showed altered chloroplast morphologies and less grana lamella, strongly indicating that plastid biogenesis was affected in the plants (Data not shown). These results show that the Phe-analogues tested herein, modified at the meta position of the phenyl ring (FIG. 1) have phytotoxic effects, influencing seed germination and plants development. It should be noted that many more phe-analogues can be easily synthesized chemically based on the present teachings.

### Example 3

### The Phenylalanine Analogue is Capable of Inhibiting Growth of Cyanobacteria

Cyanobacteria are strongly affected by the phenylalanine analogue of some embodiments of the invention—The present inventors tested the effect of the phenylalanine analogue which comprises “F” at the meta position (as R₁ in Formula I) on water samples which contain cyanobacteria, Synechocystis PCC 6803. As shown in FIG. 3B, increasing concentrations of the phenylalanine analogue (from 0 mM to 50 micromolar (μM)) resulted in bleaching of the culture of cyanobacteria contained in the water samples. FIG. 3A shows quantification of the bleaching effect on the water. The inhibition of growth rate is evident at low concentrations of the phenylalanine analogue (e.g., at 6.25 μM). The growth rate was determined by the culture absorbance at OD=730; Thus, the phenylalanine analogue has a very strong effect on cyanobacteria such as the Synechocystis PCC 6803 species.

It should be noted that the phenylalanine analogue of some embodiments of the invention (e.g., which comprises “F” at the “meta position, R₁ of Formula I) is more stable than the meta tyrosine molecule (see, FIG. 4; R₁₀ is H in Formula II).

### Example 4

### Efficacy of Meta-Tyrosine Molecule on Cyanobacteria

Experimental Results

Cyanobacteria are strongly affected by the non-protein amino acid m-Tyr—The present inventors tested the effect of m-Tyr (as schematically shown in FIG. 4) on water samples collected from lake Kinneret (Israel) which contain highly toxic cyanobacteria, Microcystis aeruginosa. As shown in FIG. 5B, increasing concentrations of the m-tyr (from 0 mM to 10 mM) resulted in bleaching of the culture of cyanobacteria contained in the water samples. FIG. 5A shows quantification of the bleaching effect on the lake water. The cell mortality is evaluated by the obvious bleaching of the culture. The growth rate was determined by the culture absorbance at OD=730 (e.g., FIG. 5C); Thus, the m-Tyr has a very strong effect on cyanobacteria, including the highly toxic cyanobacteria microcystis aeruginosa in its own native environment—e.g., the water lake samples contaminated by this bacteria. Similar results were observed using a different type of cyanobacteria, e.g., the Synechocystis PCC 6803 species (FIGS. 5C-E).

The Phe-analogues of some embodiments of the invention do not inhibit Escherichia coli, Bacillus subtilis and yeast—Of particular interest in this context is the impact of meta tyrosine on growth of other organisms. In antibacterial assays the m-Tyr did not affect cell growth of Escherichia coli and Bacillus subtilis (FIGS. 6A-B). Similarly, cultures of the yeast are not sensitive to m-Tyr, even at concentrations as high as 15 mM (data not shown), demonstrating that the mode of action of Phe-analogs appears to be specific to photosynthetic organisms such as plants and cyanobacteria.

These results demonstrate that the non-protein analogues of some embodiments of the invention, including the m-Tyr, are suitable for controlling the cyano-blooms.

Undoubtedly, m-Tyr and the synthetic Phe-analogues of some embodiments of the invention seem more suitable for controlling the cyano-blooms as compared to any known agent to date.

### Example 5

### Combined Treatment of Phenylalanine Analogues and Glyphosate

Without being bound by any theory, the present inventors have hypothesized that by application of glyphosate and blocking synthesis of aromatic amino acids, the free phenylalanine content in the cell will be greatly reduced, thereby opening a way for easier mis-incorporation of Phe-analogues into proteins via PheRSs (phenylalanyl-tRNA synthetase), and providing extra inhibition, considering production of proteins with imperfections. Such combination of dual-purpose herbicides will reduce the amount of glyphosate required to control weed infestation, making the product friendlier to the surrounding environment. An additional reason to combining these two moieties is breaking tolerance of weeds, showing resistance to glyphosate.

Here, the present inventors demonstrate that application of sub-lethal dose of Phe-analogues in parallel with glyphosate may have a profound inhibitory effect on A. thaliana root growth (FIG. 9). Compared to herbicides (e.g., glyphosate) applied alone, the performance of herbicide mixtures can be either synergistic, or additive. Additivity is the combined action, which is equal to the total response predicted by taking into account the response of each herbicide applied alone. Synergism is the combined action of two herbicides where the observed response to their joint application is greater than the response predicted by Colby method [S. R. COLBY. Calculating Synergistic and Antagonistic Responses of Herbicide Combinations. Weeds Vol. 15, No. 1 (Jan., 1967), pp. 20-22]. However, in many cases, the synergistic total increase in action is so high that Colby's criterion can be dispensed. The application of different Phe-analogues coupled with glyphosate, clearly have synergistic effect (FIG. 9).

Glyphosate-resistant weed plants exhibit a number of resistance mechanisms including restrictions in glyphosate migration within the resistant plants, mutation of the EPSPS (5-enolpyruvyl-shikimate synthetase) gene and amplification of the EPSPS gene copies on multiple chromosomes. This in turn is causing increased level of EPSPS protein, which can not be inhibited by normal level of glyphosate as it was demonstrated in Amaranthus palmeri case. In recent years, Lolium rigidum Gaudin (annual ryegrass) resistance to a number of herbicides has started to spread worldwide. The present inventors also demonstrate that local Israeli variety of Lolium, resistant to elevated concentration of glyphosate (60 folds of the recommended concentration) become more sensitive to herbicides when Phe-analogues are applied in parallel with glyphosate (FIG. 10).

Thus, these experiments demonstrate synergistic effect of the dual-herbicides technology. Interestingly, the present inventors observed that the glyphosate resistant Lolium demonstrates resistance to the Phe-analogue and glyphosate when applied separately (FIG. 10). Thus, as a proof of concept, the present inventors demonstrate that:
(a) the glyphosate levels can be significantly reduced when applied together with Phe analogs;
(b) glyphosate resistant plants became sensitive again when Phe analogues are added to the formulation.

Analysis and Discussion

These results show that the photosynthetic bacteria (Cyanobacteria) are highly susceptible to various Phe-analogues and m-Tyr. This observation is extremely important, as cyanobacteria, forming large blooms, cause severe ecological and environmental damages, and currently there are no efficient bactericides that control the growth of cyanobacterial blooms.

Intriguingly, while m-Tyr had no (or very little) effect on the fitness both of gram-positive (Bacillus subtilis) or gram-negative bacteria (E. coli), this non-protein amino acid analogue is strongly affecting cyanobacteria, even at the very low μM range concentrations. Moreover, m-Tyr has no inhibition effects on algae (chlamydomonas) even in the millimolar range.

Of great importance is that the present study indicate that other derivatives of m-Tyr, modified at the meta position of the phenyl ring have similar effects on plants, thus increasing the versatility of new potent bactericides against cyanobacterial blooms.

Viability experiments indicated that even at concentrations as low as 0.5 μM, the addition of m-Tyr to the growth media decreases mortality and induces cell death. These data also suggest that while m-Tyr is toxic to cyanobacteria, it has no obvious effects on algae (Chlorella) or marine bacteria. These results are intriguing, as they may imply that the toxicity of Phe-analogues is restricted to photosynthetic bacteria (cyanobacteria) and not to other organisms living in the aquatic environment. Thus, m-Tyr and its related Phe-analogues represent the first selective agents against cyanoblooming, a serious threat to both marine ecology and global economy.

The present inventors have tested whether other photosynthetic organisms, including cyanobacteria, are also affected by m-Tyr. This is important as currently there are no treatments to control the highly toxic effects on animals and humans caused by many harmful cyanobacterial blooms in oceans, lakes and other essential water resources globally. The effects of toxic cyanobacteria are estimated by billions of dollars annually. Remarkably, here the present inventors show that in addition to plants, cyanobacteria are also highly susceptible to m-Tyr. The results presented herein show that the non-protein amino acid analogues, which were shown to affect seed-germination in a wide variety of plant species, can also control cyanobacteria growth.

The present inventors further aim to use this data to develop efficient applications to control cyano-blooming in the natural marine environments (e.g., fish ponds, lakes, rivers and oceans). Of great importance is the strong effect of other synthetically designed Phe-analogues modified at the meta position of the aromatic ring (Formula I) on the growth and development of plants and cyanobacteria. Such synthetic compounds should provide with new and enhanced effects on plants growth and cyanobacterial blooming, without affecting the viability of other organisms leaving in the same habitats. These are key to the application of herbicides and bactericides based on non-protein amino acid analogues.

Meta-tyrosine and ortho-tyrosine and methods for its preparation are well-known in the art, and both isomers are readily available from commercial suppliers (e.g., Sigma). As an example, a method for the synthesis of ortho-tyrosine was already described in 1956 (Shaw, K., McMillan, A. and Armstrong, M. 1956. Synthesis of o-tyrosine and related phenolic acids. J. Org. Chem. 21 (6): 601-604. A method for the efficient synthesis of meta-tyrosine is described in Bender, D. and Williams, R. 1997. An Efficient Synthesis of (S)-m-Tyrosine. J. Org. Chem. 62(19): 6448:6449.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

### REFERENCES

### Additional References are Cited in Text

1. Huang, T., Rehak, L. & Jander, G. meta-Tyrosine in Festuca rubra ssp. commutata (Chewings fescue) is synthesized by hydroxylation of phenylalanine.

Phytochemistry 75, 60-6 (2012).
2. Bertin, C. et al. Grass roots chemistry: meta-tyrosine, an herbicidal nonprotein amino acid. Proc. Natl. Acad. Sci. U.S.A 104, 16964-16969 (2007).
3. Klipcan, L., Finarov, I., Moor, N. & Safro, M. G. Structural Aspects of Phenylalanylation and Quality Control in Three Major Forms of Phenylalanyl-tRNA Synthetase. J. Amino Acids 2010, 983503 (2010).
4. Kotik-Kogan, O., Moor, N., Tworowski, D. & Safro, M. Structural basis for discrimination of L-phenylalanine from L-tyrosine by phenylalanyl-tRNA synthetase. Structure 13, 1799-807 (2005).
5. Movellan, J. et al. Synthesis and evaluation as biodegradable herbicides of halogenated analogs of L-meta-tyrosine. Environ. Sci. Pollut. Res. 21, 4861-4870 (2014).
6. Paerl, H. Mitigating Harmful Cyanobacterial Blooms in a Human- and Climatically-Impacted World. Life 4, 988-1012 (2014).
7. Raven, J. A. & Giordano, M. Algae. Curr. Biol. 24, R590-R595 (2014).
8. Anderson, D. M., Cembella, A. D. & Hallegraeff, G. M. Progress in Understanding Harmful Algal Blooms: Paradigm Shifts and New Technologies for Research, Monitoring, and Management. Ann. Rev. Mar. Sci. 4, 143-176 (2012).
9. Paerl, H. W. & Otten, T. G. Harmful Cyanobacterial Blooms: Causes, Consequences, and Controls. Microb. Ecol. 65, 995-1010 (2013).
10. Burson, A. et al. Termination of a toxic Alexandrium bloom with hydrogen peroxide. Harmful Algae 31, 125-135 (2014).
11. Ahlert, D., Ruf, S. and Bock, R. (2003) Plastid protein synthesis is required for plant development in tobacco. Proc Natl Acad Sci USA, 100, 15730-15735.
12. Austin, J. R., Frost, E., Vidi, P.-A., Kessler, F. and Staehelin, L. A. (2006) Plastoglobules Are Lipoprotein Subcompartments of the Chloroplast That Are Permanently Coupled to Thylakoid Membranes and Contain Biosynthetic Enzymes. The Plant Cell, 18, 1693-1703.
13. Bertin, C., Yang, X. and Weston, L. (2003) The role of root exudates and allelochemicals in the rhizosphere. Plant and Soil, 256, 67-83.
14. Dunlop, R. A., Dean, R. T. and Rodgers, K. J. (2008) The impact of specific oxidized amino acids on protein turnover in J774 cells. Biochem J, 410, 131-140.
15. Gressel, J. (2009) Evolving understanding of the evolution of herbicide resistance. Pest Manag Sci, 65, 1164-1173.
16. Klipcan, L., Moor, N., Kessler, N. and Safro, M. G. (2009) Eukaryotic cytosolic and mitochondrial phenylalanyl-tRNA synthetases catalyze the charging of tRNA with the meta-tyrosine. Proc Natl Acad Sci USA, 106, 11045-11048.
17. Paerl, H. W. and Otten, T. G. (2013) Harmful cyanobacterial blooms: causes, consequences, and controls. Microb Ecol, 65, 995-1010.
18. Rodgers, K. J. and Shiozawa, N. (2008) Misincorporation of amino acid analogues into proteins by biosynthesis. Int J Biochem Cell Biol, 40, 1452-1466.

1. A method of inhibiting growth of photosynthetic bacterium, the method comprising contacting an effective amount of a compound represented by Formula I: 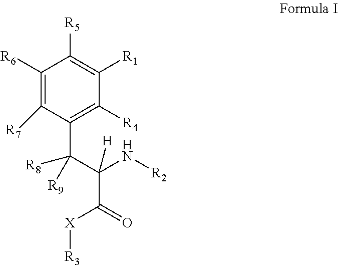
wherein:
R₁ is selected from alkyl, alkenyl, alkynyl, hydroxyalkyl, aminoalkyl, haloalkyl, halogen, nitro, cyano, amino, amidine, thiol, carboxy, and borate;
R₂ is selected from H, alkyl, alkenyl, alkynyl, cycloalkyl, heterocycloalkyl, aryl, and heteroaryl, wherein each of said alkyl, alkenyl, alkynyl, alkoxy, aryl, and heteroaryl is unsubstituted;
R₃ is selected from H, alkyl, alkenyl, alkynyl, cycloalkyl, heterocycloalkyl, aryl, and heteroaryl, wherein each of said alkyl, alkenyl, alkynyl, cycloalkyl, heterocycloalkyl, aryl, and heteroaryl is unsubstituted;
X is selected from the group consisting of O and N—Z, wherein Z is selected from the group consisting of H, alkyl, alkenyl, alkynyl, cycloalkyl, heterocycloalkyl, aryl, and heteroaryl, wherein each of said alkyl, alkenyl, alkynyl, cycloalkyl, heterocycloalkyl, aryl, and heteroaryl is unsubstituted;
R₄, R₅, R₆, and R₇ are each H; and
R₅ and R₉ are independently selected from H, hydroxyl, halogen, amino, alkyl, and haloalkyl.

2. The method of claim 1, wherein R₁ is selected from —CH₃, —CF₃, —F, —CN, —Cl, —Br, —I, —NO₂, 3-nitro-L-Tyrosine, 3,5-diiodo-L-Tyrosine, m-amidinophenyl-3-alanine, 3-ethyl-phenylalanine, meta-nitro-tyrosine, —CH₂CH₃, —NH₂, SH, C≡CH, —CH(CH₃)₂, —CH₂OH, —CH₂NH₂, —B(OH)₂, —C(CH₃)₃, and C(═O)(OH).

3. The method of claim 1, wherein R₁ is selected from —CH₃, —CF₃ and —F, optionally wherein X is O, and optionally wherein R₃-R₉ are each H.

4. A method of treating water, the method comprising contacting an effective amount of a compound represented by Formula I as defined in claim 1, with the water, thereby treating the water.

5. A composition-of-matter comprising a water-insoluble matrix and an effective amount of a compound represented by Formula I as defined in claim 1 incorporated in or on said matrix, the composition-of-matter being identified for use in treating water.

6. A device for treating water comprising at least one casing having the composition-of-matter of claim 5 embedded therein such that water flowing through said casing becomes in contact with said composition-of-matter, optionally said effective amount of said compound being capable of inhibiting growth of a photosynthetic bacterium comprised in the water;
optionally wherein said effective concentration of said compound is non-toxic to animals present in the water;
optionally wherein said treating said water is affected by reducing a concentration of at least one photosynthetic bacterium in the water;
optionally wherein said effective amount of said compound is capable of inhibiting growth of a photosynthetic bacterium comprised in the water,
and optionally wherein an effective concentration of said compound is non-toxic to animals present in the water.

7. The method of claim 1, wherein said effective amount of said compound is capable of inhibiting growth of a photosynthetic bacterium comprised in the water, and optionally wherein an effective concentration of said compound is non-toxic to animals present in the water.

8. The composition-of-matter of claim 5, wherein said effective concentration of said compound is non-toxic to animals present in the water.

9. The device of claim 6, wherein said photosynthetic bacterium comprises cyanobacterium.

10. A method of inhibiting growth of a plant, the method comprising contacting an effective amount of the compound depicted by Formula I as defined in claim 1 with the plant, thereby inhibiting the growth of the plant.

11. The method of claim 10, wherein said plant comprises an angiosperm.

12. An agricultural composition comprising the compound depicted by Formula I as defined in claim 1 and an agricultural carrier, optionally the agricultural composition further comprising an herbicide, said herbicide inhibits activity of 5-enolpyruvyl-shikimate synthetase (EPSPS) in a photosynthetic organism.

13. The agricultural composition of claim 12, wherein said herbicide is glyphosate.

14. A method inhibiting growth of a photosynthetic organism, the method comprising contacting the photosynthetic organism with a combination of an effective amount of the compound depicted by Formula I as defined by claim 1 and an effective amount of a herbicide, wherein said herbicide inhibits activity of 5-enolpyruvyl-shikimate synthetase (EPSPS) in the photosynthetic organism, thereby inhibiting the growth of the photosynthetic organism.

15. The method of claim 14, wherein said effective amount of the compound is provided prior to or concomitantly with said effective amount of said herbicide, optionally wherein said effective amount of said herbicide is reduced as compared to an amount of said herbicide required for achieving the same growth inhibition of the photosynthetic organism when administered in the absence of said effective amount of the compound, and optionally wherein said herbicide is glyphosate.

16. The method of claim 14, wherein the photosynthetic organism is a plant, optionally wherein said plant comprises an angiosperm, optionally wherein said plant comprises a weed or a weed seed, optionally wherein the photosynthetic organism is a photosynthetic bacterium, and optionally wherein the photosynthetic bacterium comprises cyanobacterium.

17. A method of growing a plant, comprising:
growing a plant over-expressing an aminoacyl tRNA synthetase (aaRS) as compared to an expression level of said aaRS in a wild type plant of the same species in the presence of an effective amount of a compound depicted by Formula I as defined by claim 1, wherein said effective amount of said compound is capable of inhibiting growth of said wild type plant of the same species, thereby growing the plant.

18. The method of claim 17, wherein said aaRS is phenylalanyl-tRNA synthetase (PheRS), optionally wherein the PheRS is a heterotetrameric bacterial PheRS composed of two PheRS-α and two PheRS-β strands, optionally wherein the aminoacyl tRNA synthetase (aaRS) is encoded by a polynucleotide which further comprises a nucleic acid sequence encoding a targeting peptide selected from the group consisting of a mitochondrial targeting peptide and a chloroplast targeting peptide.

19. The method of claim 18, wherein the bacterial PheRS is selected from the group consisting of Escherichia coli (E. coli) PheRS and Thermus thermophilus PheRS,
optionally wherein the T. thermophilus PheRS-α comprises the amino acid sequence set forth in SEQ ID NO:5; or optionally wherein the E. Coli PheRS-α comprises the amino acid sequence set forth in SEQ ID NO:3;
optionally wherein the T. thermophilus PheRS-β² comprises the amino acid sequence set forth in SEQ ID NO:6, or optionally the E. Coli PheRS-β comprises the amino acid sequence set forth in SEQ ID NO:4.
optionally wherein the E. Coli PheRS-α is encoded by a polynucleotide having the nucleic acid sequence set forth in SEQ ID NO: 1
and optionally wherein the E. Coli PheRS-β is encoded by a polynucleotide having the nucleic acid sequence set forth in SEQ ID NO:2,

20. The method of claim 17, wherein the plant is selected from a crop plant, and an ornamental plant.


SEQUENCE LISTING (8 sequences)

SEQ ID NO: 1 - DNA, 984 bp, Escherichia coli
  misc_feature 1..984: note = E. Coli PheRS subunit alpha
  source 1..984: mol_type = other DNA
atgtcacatctcgcagaactggttgccagtgcgaaggcggccattagccaggcgtcagatgttgccgcgttagacaatgtgcgcgtcgaatatttgggtaaaaaagggcacttaacccttcagatgacgaccctgcgtgagctgccgccagaagagcgtccggcagccggtgcggttatcaacgaagcgaaagagcaggttcagcaggcgctgaatgcgcgtaaagcggaactggaaagcgctgcactgaatgcgcgtctggcggcggaaacgattgatgtctctctgccaggtcgtcgcattgaaaacggcggtctgcatccggttacccgtaccatcgaccgtatcgaaagtttcttcggtgagcttggctttaccgtggcaaccgggccggaaatcgaagacgattatcataacttcgatgctctgaacattcctggtcaccacccggcgcgcgctgaccacgacactttctggtttgacgctacccgcctgctgcgtacccagacctctggcgtacagatccgcaccatgaaagcccagcagccaccgattcgtatcatcgcgcctggccgtgtttatcgtaacgactacgaccagactcacacgccgatgttccatcagatggaaggtctgattgttgataccaacatcagctttaccaacctgaaaggcacgctgcacgacttcctgcgtaacttctttgaggaagatttgcagattcgcttccgtccttcctacttcccgtttaccgaaccttctgcagaagtggatgtcatgggtaaaaacggtaaatggctggaagtactgggctgcgggatggtgcatccgaacgtgctgcgtaacgttggcatcgacccggaagtttactctggtttcgccttcgggatggggatggagcgtctgactatgttgcgttacggcgtcaccgacctgcgttcattcttcgaaaacgatctgcgtttcctcaaacagtttaaataa

SEQ ID NO: 2 - DNA, 2388 bp, Escherichia coli
  misc_feature 1..2388: note = E. Coli PheRS subunit beta
  source 1..2388: mol_type = other DNA
atgaaattcagtgaactgtggttacgcgaatgggtgaacccggcgattgatagcgatgcgctggcgaatcaaatcactatggcgggcctggaagttgacggtgtagaaccggttgccggtagcttccacggcgtggtcgttggtgaagtggttgagtgtgcgcagcatccgaacgctgacaaactgcgtgtgacaaaagtgaatgtcggcggcgatcgcctgctggacatcgtctgcggtgcgccaaactgccgtcagggcctgcgtgtggcggtagcgaccattggtgctgttctgccgggtgatttcaaaattaaagcggcgaaactgcgcggcgaaccgtctgaagggatgctgtgctccttttctgagctgggaatttctgacgaccataacggcattatcgaactgcctgcagatgcgccgattggcactgacatccgcgaatacctgaaactcgatgacaacaccatcgaaatcagcgtaacgccaaaccgtgccgactgtttaggtatcattggtgttgcgcgtgacgttgccgtgctgaatcagctgccgctggttgaaccggaaatcgttccggttggtgcgaccatcgacgacacgctgccgattacagtcgaagcgccggaagcctgcccgcgttatcttggccgtgtggtaaaaggcattaacgttaaagcgccaactccgctgtggatgaaagaaaaactgcgtcgttgcgggatccgttctatcgatgcagttgttgacgtcaccaactatgtgctgctcgaattgggccagccgatgcacgctttcgataaagatcgcattgaaggcggcattgtggtgcggatggcgaaagagggcgaaacgctggtgctgctcgacggtactgaagcgaagctgaatgctgacactctggtcatcgccgaccacaacaaggcgctggcgatgggcggcatcttcggtggcgaacactctggcgtgaatgacgaaacacaaaacgtgctgctggaatgcgctttctttagcccgctgtctatcaccggtcgtgctcgtcgtcatggcctgcatactgatgcgtctcaccgttatgagcgtggcgttgatccggcactgcagtacaaagcgatggaacgtgcgacccgtctgctgattgacatctgcggtggtgaggctggtccggtaattgatatcaccaacgaagcaacgctgccgaagcgtgcaaccatcactttacgtcgtagcaaactggatcgcctgatcggccatcatattgcggatgagcaggtaactgacattctgcgtcgtctcggctgcgaagtgaccgaaggcaaagacgagtggcaggcagttgcgccgagctggcgtttcgacatggagattgaagaagatctggtcgaagaagtcgcgcgtgtttacggctacaacaacatcccggatgagccggtacaggcaagcctgattatgggtactcaccgtgaagctgacctgtcgctcaagcgcgtgaaaacgctgctcaacgataaaggctatcaggaagtgatcacctatagcttcgttgatccgaaagtgcagcagatgatccatccaggcgttgaagccttactgctgccaagcccgatctctgttgaaatgtcagcaatgcgtctttctctgtggaccggcctgctggcaaccgtggtgtacaaccagaaccgtcagcagaaccgtgtgcgcattttcgaaagcggtctgcgtttcgtaccagatactcaggcaccgttgggcattcgtcaggatctgatgttagccggtgtgatttgcggtaaccgttacgaagagcactggaacctggcaaaagagaccgttgatttctatgatttgaaaggcgatcttgaatccgttctcgacctgaccggtaaactgaatgaggttgagttccgtgcagaagcgaatccggcactgcatccggggcaatccgcagcgatttatctgaaaggtgaacgtattggttttgttggggttgttcatcctgaactggaacgtaaactggatcttaacggtcgcactctggtgttcgaactggagtggaacaagctcgcagaccgcgtggtgcctcaggcgcgcgagatttctcgcttcccggcgaaccgtcgtgacatcgcggtggtggtcgcagaaaacgttcccgcagcggatattttatccgaatgtaagaaagttggcgtaaatcaggtagttggcgtaaacttatttgacgtgtaccgcggtaagggtgttgcggaggggtataagagcctcgccataagcctgatcctgcaagataccagccgtacactcgaagaagaggagattgccgctaccgtcgccaaatgtgtagaggcattaaaagagcgattccaggcatcattgagggattga

SEQ ID NO: 3 - protein, 327 aa, Escherichia coli
  REGION 1..327: note = MISC_FEATURE - E. Coli PheRS subunit alpha
MSHLAELVASAKAAISQASDVAALDNVRVEYLGKKGHLTLQMTTLRELPPEERPAAGAVINEAKEQVQQALNARKAELESAALNARLAAETIDVSLPGRRIENGGLHPVTRTIDRIESFFGELGFTVATGPEIEDDYHNFDALNIPGHHPARADHDTFWFDTTRLLRTQTSGVQIRTMKAQQPPIRIIAPGRVYRNDYDQTHTPMFHQMEGLIVDTNISFTNLKGTLHDFLRNFFEEDLQIRFRPSYFPFTEPSAEVDVMGKNGKWLEVLGCGMVHPNVLRNVGIDPEVYSGFAFGMGMERLTMLRYGVTDLRSFFENDLRFLKQFK

SEQ ID NO: 4 - protein, 795 aa, Escherichia coli
  REGION 1..795: note = MISC_FEATURE - E. Coli PheRS subunit beta
MKFSELWLREWVNPAIDSDALANQITMAGLEVDGVEPVAGSFHGVVVGEVVECAQHPNADKLRVTKVNVGGDRLLDIVCGAPNCRQGLRVAVATIGAVLPGDFKIKAAKLRGEPSEGMLCSFSELGISDDHSGIIELPADAPIGTDIREYLKLDDNTIEISVTPNRADCLGIIGVARDVAVLNQLPLVQPEIVPVGATIDDTLPITVEAPEACPRYLGRVVKGINVKAPTPLWMKEKLRRCGIRSIDAVVDVTNYVLLELGQPMHAFDKDRIEGGIVVRMAKEGETLVLLDGTEAKLNADTLVIADHNKALAMGGIFGGEHSGVNDETQNVLLECAFFSPLSITGRARRHGLHTDASHRYERGVDPALQHKAMERATRLLIDICGGEAGPVIDITNEATLPKRATITLRRSKLDRLIGHHIADEQVTDILRRLGCEVTEGKDEWQAVAPSWRFDMEIEEDLVEEVARVYGYNNIPDEPVQASLIMGTHREADLSLKRVKTLLNDKGYQEVITYSFVDPKVQQMIHPGVEALLLPSPISVEMSAMRLSLWTGLLATVVYNQNRQQNRVRIFESGLRFVPDTQAPLGIRQDLMLAGVICGNRYEEHWNLAKETVDFYDLKGDLESVLDLTGKLNEVEFRAEANPALHPGQSAAIYLKGERIGFVGVVHPELERKLDLNGRTLVFELEWNKLADRVVPQAREISRFPANRRDIAVVVAENVPAADILSECKKVGVNQVVGVNLFDVYRGKGVAEGYKSLAISLILQDTSRTLEEEEIAATVAKCVEALKERFQASLRD

SEQ ID NO: 5 - protein, 350 aa, Thermus thermophilus
  REGION 1..350: note = MISC_FEATURE - T. thermophilus PheRS subunit alpha
MLEEALAAIQNARDLEELKALKARYLGKKGLLTQEMKGLSALPLEERRKRGQELNAIKAALEAALEAREKALEEAALKEALERERVDVSLPGASLFSGGLHPITLMERELVEIFRALGYQAVEGPEVESEFFNFDALNIPEHHPARDMWDTFWLTGEGFRLEGPLGEEVEGRLLLRTHTSPMQVRYMVAHTPPFRIVVPGRVFRFEQTDATHEAVFHQLEGLVVGEGIAMAHLKGAIYELAQALFGPDSKVRFQPVYFPFVEPGAQFAVWWPEGGKWLELGGAGMVHPKVFQAVDAYRERLGLPPAYRGVTGFAFGLGVERLAMLRYGIPDIRYFFGGRLKFLEQFKGVL

SEQ ID NO: 6 - protein, 785 aa, Thermus thermophilus
  REGION 1..785: note = MISC_FEATURE - T. thermophilus PheRS subunit beta
MRVPFSWLKAYVPELESPEVLEERLAGLGFETDRIERVFPIPRGVVFARVLEAHPIPGTRLKRLVLDAGRTVEVVSGAENARKGIGVALALPGTELPGLGQKVGERVIQGVRSFGMALSPRELGVGEYGGGLLEFPEDALPPGTPLSEAWPEEVVLDLEVTPNRPDALGLLGLARDLHALGYALVEPEAALKAEALPLPFALKVEDPEGAPHFTLGYAFGLRVAPSPLWMQRALFAAGMRPINNVVDVTNYVMLERAQPMHAFDLRFVGEGIAVRRAREGERLKTLDGVERTLHPEDLVIAGWRGEESFPLGLAGVMGGAESEVREDTEAIALEVACFDPVSIRKTARRHGLRTEASHRFERGVDPLGQVPAQRRALSLLQALAGARVAEALLEAGSPKPPEAIPFRPEYANRLLGTSYPEAEQIAILKRLGCRVEGEGPTYRVTPPSHRLDLRLEEDLVEEVARIQGYETIPLALPAFFPAPDNRGVEAPYRKEQRLREVLSGLGFQEVYTYSFMDPEDARRFRLDPPRLLLLNPLAPEKAALRTHLFPGLVRVLKENLDLDRPERALLFEVGRVFREREETHLAGLLFGEGVGLPWAKERLSGYFLLKGYLEALFARLGLAFRVEAQAFPFLHPGVSGRVLVEGEEVGFLGALHPEIAQELELPPVHLFELRLPLPDKPLAFQDPSRHPAAFRDLAVVVPAPTPYGEVEALVREAAGPYLESLALFDLYQGPPLPEGHKSLAFHLRFRHPKRTLRDEEVEEAVSRVAEALRARGFGLRGLDTP

SEQ ID NO: 7 - DNA, 123 bp, synthetic construct
  misc_feature 1..123: note = Synthetic polynucleotide
  source 1..123: mol_type = other DNA
ggaatttctacaatggtgggctcagctctcaggagaggtgcccatgcatatgtctacctggtgagtaaggccagtcacatctccagaggccatcagcaccaggcctggggatcgaggcctcct

SEQ ID NO: 8 - protein, 37 aa, synthetic construct
  REGION 1..37: note = Synthetic Peptide
MVGSALRRGAHAYVYLVSKASHISRGHQHQAWGSRPP